(19) United States
(12) Patent Application Publication
(10) Pub. No.: US 2026/0100733 A1
(43) Pub. Date: Apr. 9, 2026

(54) METHODS, ARCHITECTURES, APPARATUSES AND SYSTEMS FOR PRECODER REPORTING

(71) Applicant: InterDigital Patent Holdings, Inc., Wilmington, DE (US)

(72) Inventors: Salah Elhoushy, LaSalle (CA); Afshin Haghighat, Ile-Bizard (CA); Patrick Svedman, Stockholm (SE); Allan Yingming Tsai, Boonton, NJ (US); Yifan Li, Conshohocken, PA (US); Chia-Hung Wei, Chesterbrook, PA (US); Benoit Pelletier, Roxboro (CA); Jyotish Robin, New York, NY (US); Ravikumar Pragada, Warrington, PA (US)

(21) Appl. No.: 18/906,597

(22) Filed: Oct. 4, 2024

(51) Int. Cl. H04B 7/0456

(52) U.S. Cl. CPC H04B 7/0456

(57) ABSTRACT

Procedures, methods, architectures, apparatuses, systems, devices, and computer program products for reporting of precoders, in particular hybrid precoders for near-field and far-field operation. A wireless transmit/receive unit measures one or more downlink, DL, reference signals, RSs, to obtain a measurement result, determines, based on the measurement result, at least a first set of vectors, determines, based on the measurement result, at least a second set of vectors having complex valued elements, across which phase progression is non-linear, determines precoder information comprising at least the first set of vectors and the second set of vectors, and transmits, to a transmission reception point, information indicating the precoder information.

### BACKGROUND

The present disclosure is generally directed to the fields of communications, software and encoding, including, for example, to methods, architectures, apparatuses, systems directed to reporting of precoders, in particular hybrid precoders for near-field and far-field operation.

### SUMMARY

In a first aspect, the present principles are directed to a wireless transmit/receive unit, WTRU, including at least one processor configured to measure one or more downlink, DL, reference signals, RSs, to obtain a measurement result, determine, based on the measurement result, at least a first set of vectors, determine, based on the measurement result, at least a second set of vectors having complex valued elements, across which phase progression is non-linear, determine precoder information including at least the first set of vectors and the second set of vectors, and transmit, to a transmission reception point, information indicating the precoder information.

The at least one processor can be configured to determine no more than a first maximum number of vectors for the first set of vectors, and no more than a second maximum number of vectors for the second set of vectors.

The at least one processor can be configured to determine, based on the measurement result, one or more phase correction vectors, and determine the second set of vectors by respectively applying the one or more phase correction vectors to a determined third set of vectors that respectively are Kronecker products of two vectors having complex valued elements, across which phase progression is linear, and the information indicating the precoder information can further include information indicative of the one or more phase correction vectors. The first set of vectors can be determined from a first subset of a fourth set of vectors that respectively are Kronecker products of two vectors having complex valued elements, across which phase progression is linear, and the third set of vectors can be determined from a second subset of the fourth set of vectors. Identical phase correction vectors can be applied to the vectors of the third set. At least one factor of the Kronecker products can have a single element.

The first set of vectors can correspond to far-field, FF, precoding and the second set of vectors to near-field, NF, precoding.

The transmitted precoder information can include at least one of information indicative of the first set of vectors, information indicative of the second set of vectors.

The at least one processor can be configured to apply the one or more phase correction vectors to the third set of determined vectors using respective element-wise multiplication between the vector and the phase correction vector.

The at least one processor can be configured to determine, based on the measurement result, a first scaling factor for the first set of vectors and a second scaling factor for the second set of vectors, and apply, before determining the precoder information, the first scaling factor to the first set of vectors and the second scaling factor to the second set of vectors.

The first set of vectors can respectively be Kronecker products of two vectors having complex valued elements, across which phase progression is linear.

The information indicating the precoder information can include a subset of the vectors of the first set of vectors and the second set of vectors.

In a second aspect, the present principles are directed to a method at a wireless transmit/receive unit, WTRU, including measuring one or more downlink, DL, reference signals, RSs, to obtain a measurement result, determining, based on the measurement result, at least a first set of vectors, determining, based on the measurement result, at least a second set of vectors having complex valued elements, across which phase progression is non-linear, determining precoder information including at least the first set of vectors and the second set of vectors, and transmitting, to a transmission reception point, information indicating the precoder information.

The first set of vectors can include no more than a first maximum number of vectors, and the second set of vectors no more than a second maximum number of vectors.

The method can further include determining, based on the measurement result, one or more phase correction vectors, and wherein the second set of vectors are determined by respectively applying the one or more phase correction vectors to a determined third set of vectors that respectively are Kronecker products of two vectors having complex valued elements, across which phase progression is linear, and wherein the information indicating the precoder information can further include information indicative of the one or more phase correction vectors.

The first set of vectors can correspond to far-field, FF, precoding and the second set of vectors to near-field, NF, precoding.

The transmitted precoder information can include at least one of information indicative of the first set of vectors, information indicative of the second set of vectors.

The method can further include determining, based on the measurement result, a first scaling factor for the first set of vectors and a second scaling factor for the second set of vectors, and applying, before determining the precoder information, the first scaling factor to the first set of vectors and the second scaling factor to the second set of vectors.

The first set of vectors can respectively be Kronecker products of two vectors having complex valued elements, across which phase progression is linear.

The information indicating the precoder information can include a subset of the vectors of the first set of vectors and the second set of vectors.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a flowchart of a method of construction and reporting of a hybrid precoder according to an embodiment of the present principles;

FIG. 3 illustrates a flowchart of a method of construction and reporting of a hybrid NF-FF precoder with FF beams and NF beams according to an embodiment of the present principles;

FIG. 4 is a schematic illustration of UE determination of a hybrid NF-FF precoder;

FIG. 5 illustrates a flowchart of a method of construction and reporting of a NF precoder with per group of FF beam beamfocusing parameter according to an embodiment of the present principles; and

FIG. 6 illustrates a flowchart of a method of determination of reporting updated or new precoder and reporting format of an updated precoder.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

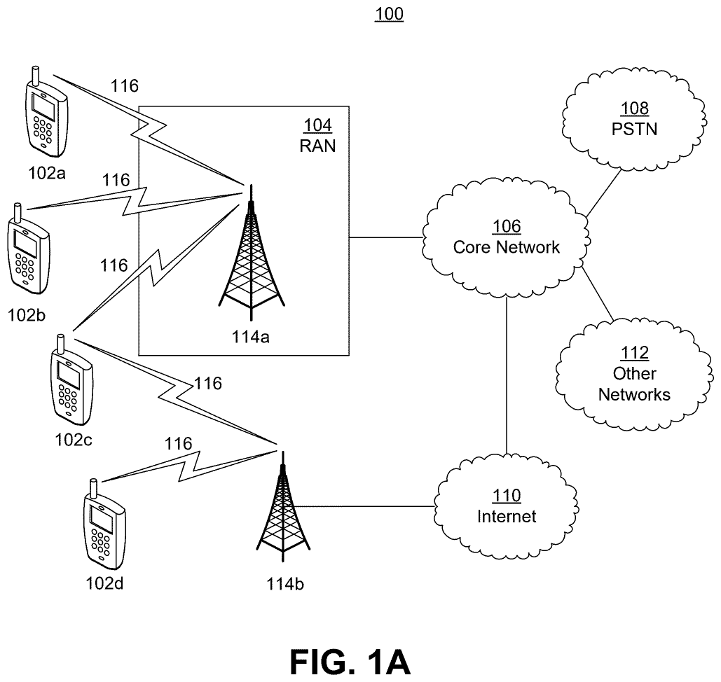

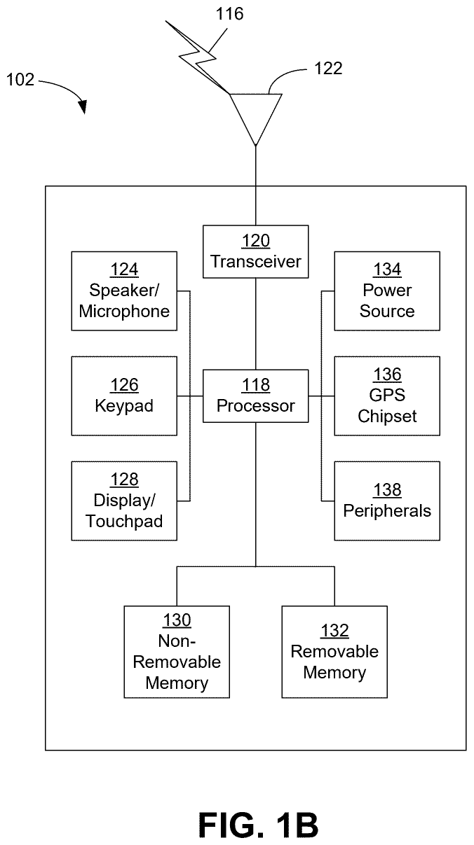

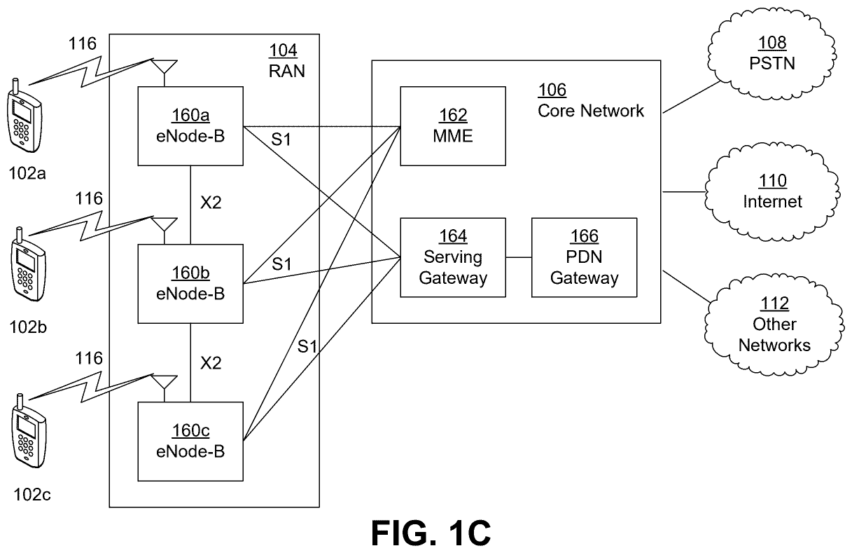

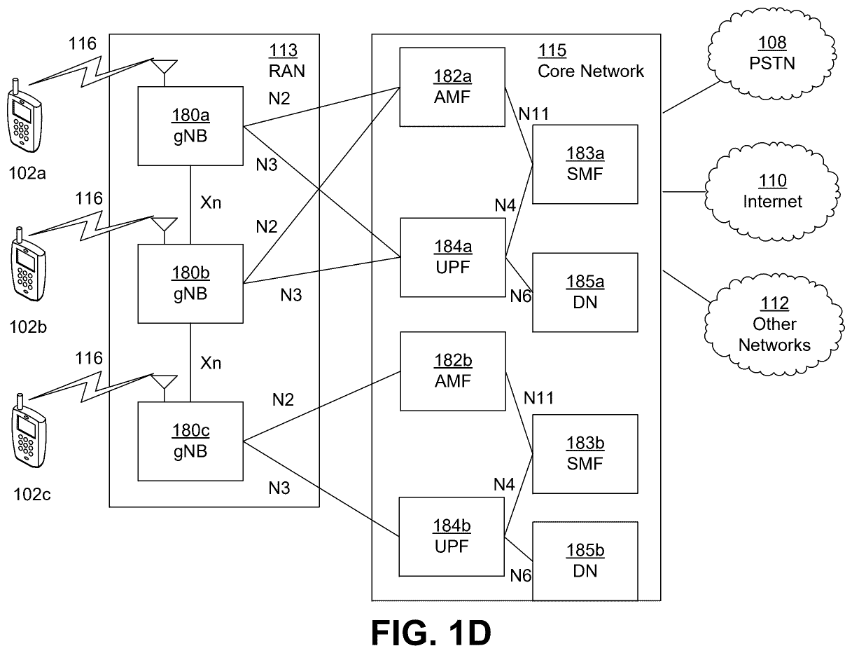

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Massive multiple-input multiple-output (MIMO) is one of the most successful technologies in recent wireless communication systems, such as 5G. In a traditional massive MIMO system, a transmission and reception point (TRP) is equipped with a large number of antennas. Legacy massive MIMO communication systems are typically designed based on the assumption that the transmission/reception happens in the far field (FF), which means that the radio wave propagation can be accurately modeled as a planar wave. However, with increasingly large TRP arrays in relation to the wavelength and with denser TRP deployments, the likelihood of UEs being located within the Fresnel region in which Near Field (NF) propagation takes place increases. The Rayleigh distance R can be used as the demarcation boundary between the Fresnel region and the far (i.e. Fraunhofer) region. The Rayleigh distance R is defined to be R=2D²/λ″ where D is the smallest diameter of a circle that encloses the array aperture and λ is wavelength.

In NF, the planar wave approximation in no longer accurate and electromagnetic wavefronts are modeled as spherical waves instead of planar waves. Accordingly, applying legacy FF transmission and reception techniques to a UE located within the NF region may lead to performance losses, such as reduced array gains.

It may happen that the UE is in a cell with hybrid field operation where some areas of the cell experience NF propagation while other areas experience FF propagation, in which case the UE may use different types of precoders. It may also happen that a UE with a multi-path channel may experience some paths with NF propagation and other paths with FF propagation, e.g., a reflection from the FF into the NF.

The legacy Channel State Information (CSI) framework is optimized for users located in the FF region, which can lead to different shortcomings of the framework. For example, taking into account the NF propagation, a cell or a UE may experience a hybrid field operation, the UE may be configured to construct and report precoders with different types at different time instants, and the UE may need to determine and report parameters indicating precoder attributes based on the configured precoder type. In addition, the legacy CSI framework considers UE construction and reporting of parameters indicating a precoder for UE located in the FF region but does not support hybrid NF-FF precoders.

It will thus be appreciated that it can be advantageous to enhance CSI framework to enable UE construction and reporting of a precoder for a hybrid field operation.

Very briefly stated, to be described in detail later, in the present principles, a UE is configured with a precoder type “hybrid precoder” and one or more parameters for constructing a hybrid precoder. The UE determines a hybrid precoder including a first precoder (e.g., FF precoder) and a second precoder (e.g., NF precoder) using one or more of the configured parameters. Then, the UE reports the beams of the first and second precoders in the hybrid precoder.

In an example embodiment, which can enable the reporting of a hybrid precoder including a NF precoder and an FF precoder, this is achieved as follows.

The UE receives a configuration information, which includes one or more of a CSI-configuration, including resource type, e.g., aperiodic CSI-RS, precoder type, for example, a first type (e.g., FF), a second type (e.g., NF), a third type (e.g., Hybrid, i.e. FF and NF), a first codebook (e.g., codebook based on FF basis beams, i.e. possible precoder vectors), a second codebook (e.g., codebook of phase correction vectors), a total number of beams (L) in the configured precoder type, a maximum number of basis beams per the first and the second precoders, a pair of scaling factor for the first and the second precoders, a target performance metric, e.g., signal-to-noise-plus-interference ratio, SINR, minimum inter/intra-precoder interference for precoder construction, etc.

The UE receives a downlink control information (DCI) to trigger an aperiodic CSI measurement on the configured downlink (DL) CSI-RS.

Based on the received DL CSI-RS, when the third type precoder is configured, the UE determines a hybrid precoder including the first and the second precoder, according to the configured maximum number of basis beams per precoder. The UE can for example apply the scaling factors for each precoder, and/or determine of the combination of the first and the second precoders (i.e., hybrid precoder) by selecting the basis beams that result in meeting a target performance metric, e.g., minimum inter/intra-precoder interference, where the first precoder is selected from the first codebook (e.g., far field codebook) and the second precoder is jointly selected from the first codebook (far field) and the second codebook (phase correction vectors).

The UE then reports the determined hybrid NF-FF precoder through reporting one or more of an indication of the selected beams for constructing the first precoder, an indication of the selected beams for constructing the second precoder, an indication of the determined phase correction vector for each selected beam for constructing the second precoder, and an indication of an association between the selected beams for constructing the second precoder and the selected phase correction vectors.

As already mentioned, in practice, a cell may include regions experiencing NF propagation and regions experiencing FF propagation. Some users may thus be located in the NF region, while other users may be located in the FF region. In addition, for a particular UE's channel, different channel paths may experience different propagation. For instance, while some channel paths of a particular UE's channel may experience NF propagation, other channel paths may experience FF propagation. In other words, a cell may be associated with hybrid field operation.

Since a UE located in a cell with hybrid field operation may experience different conditions based on its location in the cell, the UE may be configured with a specific type of precoder for DL transmission based on UE conditions. Accordingly, a unified CSI framework that can support various types of required precoders for UEs located in a cell with hybrid field operation is necessary to support UEs with their QoS requirements.

### Multi-Precoder-Based Framework for Hybrid Field Operation

As will be appreciated, different types of precoders exist.

NF Precoder with Per-FF Beam Beamfocusing Parameter

The UE may determine a NF precoder including one or more NF beams by applying the same or different beamfocusing parameters to construct the different NF beams. In particular, the UE can construct each NF beam by selecting an FF beam and a corresponding beamfocusing parameter. This stems from the fact that different FF beams selected to construct different NF beams may correspond to different paths with different distances and different angles and hence require different phase correction factors (e.g., different beamfocusing parameters).

In an example, the final NF precoder includes Z beams, the NF precoder W_{NF}^{l} for layer l (for example, l=0, . . . , (number of precoder layers-1)) may be

$${W}_{N F}^{l} = {ϵ}_{l} {\sum }_{i = 0}^{L - 1} {w}_{i , l} ( {v}^{( i )} ⊙ {b}^{( i )} ( {c}_{i} ) ) ,$$

where b⁽ⁱ⁾(cᵢ) is the phase correction factor (a complex-valued vector) applied to the i^{th} selected FF beam v⁽ⁱ⁾ (a complex-valued vector) to construct the i^{th} NF beam, and wherein ⊙ denotes element-wise multiplication. The scalar parameter cᵢ denotes the beamfocusing parameter used to construct the phase correction vector b⁽ⁱ⁾(cᵢ). The term ϵₗ represents a normalization factor. In one example, the term ϵₗ can be expressed by

$${ϵ}_{l} = 1 / \sqrt{{N}_{1} {N}_{2} {{Σ}_{i = 0}^{L - 1} ( {P}_{l , i}^{( 1 )} {P}_{l , i}^{( 2 )} )}^{2}} ,$$

where N₁ and N₂ denote the number of horizontal and vertical antenna ports (e.g., antenna elements) while P_{l,i}⁽¹⁾ and

$${P}_{l , i}^{( 2 )}$$

denote the wide-band and narrow-band amplitude coefficients for the i^{th} selected beam at layer l, respectively. The term w_{i,l} denotes a weighting factor for the i^{th} selected beam at layer l. In one example, w_{i,l} can be expressed by

$${w}_{i , l} = {P}_{l , i}^{( 1 )} {P}_{l , i}^{( 2 )} {φ}_{l , i} ,$$

where φ_{l,i} denotes the phase coefficient parameter for the i^{th} selected beam at layer l.

In case of a NF precoder with per NF beam beamfocusing parameter, the UE needs to report both the FF beams used for NF beam determination and the corresponding beamfocusing parameters c used to construct the corresponding phase correction factors.

NF Precoder with Per-Group of FF Beams Beamfocusing Parameter

The UE may determine a NF precoder including one or more NF beams through grouping the selected FF beams for constructing NF beams into one or more groups. NF beams constructed from FF beams within the same group are constructed using the same beamfocusing parameter. However, NF beams constructed from FF beams belonging to different groups are constructed using separate beamfocusing parameters, which may or may not be different. This precoder type is suitable for scenarios where, while some beams may require different beamfocusing parameters (e.g., beams corresponding LoS and NLoS paths), one or more beams may share the beamfocusing parameters (e.g., different NLoS beams).

Considering that the final NF precoder includes G groups of FF beams and the g^{th} group of FF beams includes L_{g} beams and a total number of beams is

$$L = {Σ}_{g = 0}^{G} {L}_{g} ,$$

the NF precoder

$${W}_{N F}^{l}$$

for layer l will be

$${W}_{N F}^{l} = {ϵ}_{l} {\sum }_{g = 0}^{G} {\sum }_{{i}_{g} = 0}^{{L}_{g} - 1} {w}_{{i}_{g} , l} ( {v}^{( {i}_{g} )} ⊙ {b}^{( {i}_{g} )} ( {c}_{g} ) ) ,$$

where c_{g} is the beamfocusing parameter applied to the g^{th} group of FF beams to construct L_{g} NF beams with the same beamfocusing parameter.

A special case of this precoder type is when only one group of beams exits wherein all NF beams share the beamfocusing parameter (e.g., beamfocusing parameter is applied on the FF precoder level). In other words, a single beamfocusing parameter is applied to construct different NF beams.

Considering that the final NF precoder consists of L beams, the NF precoder W_{NF}^{l} for layer l will be

$${W}_{N F}^{l} = {ϵ}_{l} {\sum }_{i = 0}^{L - 1} {w}_{i , l} ( {v}^{( i )} ⊙ {b}^{( i )} ( c ) ) ,$$

where c is the beamfocusing parameter applied to all selected FF beams to construct all NF beams with the same beamfocusing parameter.

For a NF precoder with per-group of FF beams beamfocusing parameter, the UE reports the FF beams for each group and the corresponding beamfocusing parameters c_{g}.

In some cases, L_{g} is the same for each g. For example, L_{g} may be given by L/G, with rounding if needed, wherein G may be configured.

### Hybrid NF-FF Precoder

The UE may determine a hybrid NF-FF precoder including a combination of NF beams and FF beams. The UE may construct the NF beams by applying different beamfocusing parameters to the selected FF beams for NF beams construction. Alternatively, the different selected FF beams for constructing NF beams may be divided into groups where the beamfocusing parameter is common for FF beams within each group and different groups will have different beamfocusing parameters.

In some cases, the final hybrid NF-FF precoder includes L_{NF} NF beams and L_{FF} FF beams where the precoder includes a total number of L beams where L=L_{NF}+L_{FF}. Also, NF beams are constructed using different beamfocusing parameters, the hybrid NF-FF precoder W_{HY}^{l} for layer l is

$${W}_{H Y}^{l} = {ϵ}_{l} ( {\sum }_{{i}_{F F} = 0}^{{L}_{F F} - 1} {w}_{{i}_{F F}} {v}^{( {i}_{F F} )} + {\sum }_{{i}_{N F} = 0}^{{L}_{N F} - 1} {W}_{{l}_{N F}} ( {v}^{( {i}_{N F} )} ⊙ {b}^{( {i}_{N F} )} ( {c}_{{i}_{N F}} ) ) ) .$$

Alternatively, in case different selected FF beams for constructing NF beams are grouped into different groups where UE selects a single beamfocusing parameter for each group, the hybrid NF-FF precoder W_{HY}^{l} for layer l is

$${W}_{H Y}^{l} = {ϵ}_{l} ( {\sum }_{{i}_{F F} = 0}^{{L}_{F F} - 1} {w}_{{i}_{F F}} {v}^{( {i}_{F F} )} + {\sum }_{g = 0}^{G} {\sum }_{{i}_{g} = 0}^{{L}_{g} - 1} {w}_{{i}_{g} , l} ( {v}^{( {i}_{g} )} ⊙ {b}^{( {i}_{g} )} ( {c}_{g} ) ) ) ,$$

where

$$L = {L}_{F F} + {Σ}_{g = 0}^{G} {L}_{g} .$$

In case of hybrid a NF-FF precoder, the UE indicates to the NW which of the reported beams are FF beams and which are NF beams. Also, for the NF beams, the UE reports the selected NF beams and beamfocusing parameters to construct the NF beams.

### Reporting of Layer-Dependent/Independent Beamfocusing Parameters

For one or more of the described precoder types, the UE may determine and report beamfocusing parameters independent of the transmission layer, e.g., the UE determines and reports common beamfocusing parameters for all transmission layers. In a different approach, the UE may determine and report separate beamfocusing parameters for different transmission layers. For instance, in case of NF precoder with per group of FF beams beamfocusing parameters where same beamfocusing parameter is applied to more than one FF beam, the UE may change the beamfocusing parameter from one transmission layer to another.

### Reporting Updated Precoder

The described types of precoders for hybrid field operation leads to an increase in the reporting overhead due to the large number of attributes describing each precoder type. One way to reduce the reporting overhead is to send information indicating an update to a precoder rather than a new precoder. For instance, the UE may report an update to a previously reported precoder, e.g., the UE may report update to one or more of the previously reported attributes of latest reported precoder, or the UE may report additional parameters to previously reported attributes of latest reported precoder.

Additionally, the UE may determine to report updated or new precoder based on NW configurations and on UE measurements and preconfigured conditions.

### Orthogonality Between Different NF Beams

Consider a set of NF beams including one or more NF beams with different focus distances and/or angles. The set of NF beams is constructed using a codebook of FF beams (e.g., 1-D codebook of DFT beams) and one or more beamfocusing parameters (e.g., one or more focus distances where the beamfocusing parameter is calculated as a function of the focus distance r, e.g., c≅Δ²/2r, where A denotes the antenna spacing.

In an example for DFT codebook, the UE may be configured with a DFT codebook which includes N DFT beams (e.g., spatial direction vectors (SD vectors)). The UE can determine the number of beams N in the codebook as a function of the number of horizontal antenna ports (N₁) in a Uniform Planar Array (UPA) at a TRP, the number of vertical antenna ports (N₂) in a UPA at a TRP, the oversampling factor in horizontal direction (O₁), the oversampling factor in vertical direction (O₂), and the antenna polarization. For instance, N=2 (N₁O₁) (N₂O₂) for cross polarization UPA and N=(N₁O₁) (N₂O₂) for single polarization UPA.

### Cross Correlation Between Different DFT Beams

As an example, assume a TRP with Uniform Linear Array (ULA) with N₁=128, N₂=1. The codebook of DFT beams is generated using oversampling factor O₁=O₂=1. In addition, the Rayleigh distance is 185.98m.

There is cross correlation between the different NF beams in a set of NF beams constructed using the codebook of DFT beams and a single beamfocusing parameter, e.g., all NF beams included in the set of NF beams have the same focus distance (referred to as angular cross correlation). Different NF beams constructed at a focus distance r=∞ (at which the constructed NF beams represent FF beams, e.g., DFT beams) are orthogonal, while there is increasing cross correlation between NF beams constructed with decreasing distance.

For a set of NF spot beams constructed using different beamfocusing parameters (focus distances) using the same DFT beam, e.g., different NF beams within the set of NF beams targets different focus distances within the same angle, there is (radial) cross correlation between different NF beams with different focus distances. However, the cross correlation becomes smaller at lower distances, e.g., there is small cross-correlation between generated NF beams within the focus region.

For two sets of NF spot beams where the NF beams in each set of NF beams are constructed using the codebook of DFT beams and a single beamfocusing parameter, there is cross correlation between NF spot beams from both sets of NF spot beams. In other words, there is (angular-radial) cross correlation between constructed NF beams at different focus distances and different angles.

Similar to the pure NF case, there may be cross correlation between a NF beam and an FF beam. Due to the correlation between the beams used for precoder construction, the UE can aim to design the precoder in a way that minimizes the interference between different transmission layers as well as inter-UE interference.

### Terminology

### Beamfocusing Parameter

Beamfocusing parameter c refers to the parameter that the UE applies to construct the required phase correction vector b to be applied to an FF beam to construct a NF spot beam.

It is assumed that the UE can construct a NF beam through selecting an FF beam and a beamfocusing parameter to be applied to this FF beam.

A beamfocusing parameter may correspond to one or more phase correction factors (e.g., phase correction vectors). For instance, for a given FF beam, a beamfocusing parameter may correspond to a phase correction factor while for different FF beams a beamfocusing parameter may correspond to different phase correction factors.

In another example, for different FF beams, a beamfocusing parameter may correspond to the same phase correction factor.

The beamfocusing parameter c may take various forms. For instance, the beamfocusing parameter can be expressed as a function of one or more constants, which may be configurable, and a distance r (e.g., focus distance), which the UE may determine, explicitly or implicitly. The distance r could for example represent the distance between the UE (e.g., a UE antenna, antenna array or antenna panel) and a TRP (e.g., a reference point in a TRP antenna array such as the center, an edge or a corner, or the distance between a scatterer and a TRP). As an example, c can be expressed as a function of the distance r and a constant A, such that

$$c = f ( r , A ) .$$

In one example, the beamfocusing parameter c may be inversely proportional to the distance r such as c=A/r, or the beamfocusing parameter may be proportional to r, such as c=A*r.

In another example, the beamfocusing parameter can be represented as a function of the distance r, the wavelength λ, which may be configured to or determined by the UE, and one or more constants. For example, c can be expressed as a function of the distance r, the wavelength λ, and a constant A

$$c = f ( r , λ , A ) .$$

Herein, a non-limitative example beamfocusing parameter c inversely proportional to r, specifically, c≅Δ²/2r, will be used. However, the present principles are applicable for any form of c, e.g., the ones already given.

It is noted that some embodiments are described such that increasing the distance r (e.g., as UE moves away from a TRP) corresponds to a decrease of a beamfocusing parameter c, which may be in accordance with the considered example that c is inversely proportional to r. Similarly, decreasing the distance r (e.g., as UE moves towards a TRP) may correspond to increasing a beamfocusing parameter c. If a different form of c is used, e.g., a form in which c is proportional to r, embodiments may be adjusted accordingly, so that increasing a distance r leads to increasing the value of beamfocusing parameter c, and decreasing the distance r leads to decreasing the value of beamfocusing parameter c.

### Set of Beamfocusing Parameters

A beamfocusing parameter may take on a value from a set of parameter values, e.g., a set of one or more discrete values, and/or one or more ranges of values. A set of beamfocusing parameters may refer to a set of parameter values for one or more beamfocusing parameter(s). The beamfocusing parameters in the set may be associated with parameter indices. For instance, the indices may be assigned to parameter values in the set, e.g., in an ascending (or descending) order based on the parameter value, wherein the smallest (or largest) parameter value may be associated with the lowest parameter index (e.g., 0 or 1).

### Subset of Beamfocusing Parameters

A subset of beamfocusing parameters includes one or more beamfocusing parameters, e.g., from the set of beamfocusing parameters. A subset of beamfocusing parameters may be associated with a certain angular direction, region, distance range, etc.

A subset of beamfocusing parameters can be seen as one or more beamfocusing parameters that are grouped together in one group.

The UE may determine, e.g., be configured with, multiple subsets of beamfocusing parameters where each subset is associated with a parameter subset index where the index may be global or local (e.g., local with a certain angle range, etc.).

In general, herein, a global index may be applicable within a context, such as a serving cell, a UE, etc.

Additionally, each included beamfocusing parameter within a subset of beamfocusing parameters is associated with a parameter index, e.g., corresponding to the index of the beamfocusing parameter in the set of subsets of beamfocusing parameters, or an index local within the subset. Also, different beamfocusing parameters within a subset leads to different constructs spot beams.

### Set of Subsets of Beamfocusing Parameters

A set of subsets of beamfocusing parameters may include one or more subsets of beamfocusing parameters.

A set of subsets, as well as the subset(s) therein, may be applicable to a context, for instance, one or more serving cell(s), one or more bandwidth part(s), e.g., of one or more serving cell(s), one or more carrier(s), one or more frequency band(s), one or more frequency range(s), one or more transmission and reception points (TRPs), one or more network node(s), etc., or any combination thereof. Different sets of subsets may be applicable to different contexts.

A set of beamfocusing parameters may correspond to a codebook of beamfocusing parameters, a codebook of NF factors, a codebook of correction factors, a codebook of phase correction factors, a codebook of phase correction precoders, and a codebook of phase correction vectors.

A codebook of phase correction vectors may correspond to a codebook of phase correction precoders, a codebook of NF factors, a codebook of beamfocusing parameters, and a codebook of phase correction factors (e.g., phase correction vectors).

A codebook of correction factors may include one or more subsets of correction factors. Similarly, a codebook of beamfocusing parameters may include one or more subsets of beamfocusing parameters. Also, a codebook of NF factors may include one or more subsets of NF factors. A codebook of phase correction factors may include one or more subsets of phase correction factors.

### FF Beam

An FF beam may correspond to a beam that focuses energy in a particular spatial direction. An FF beam may achieve the same beamforming gain, regardless of the distance between the transmitter and receiver, as long as the far-field approximation is applicable.

An FF beam may correspond to a real- or complex-valued matrix, e.g., a vector for instance a precoding vector. Various examples with vectors used herein are non-limiting and equally applicable to matrices, since a matrix can be converted to a vector, e.g., by stacking columns or rows of the matrix into the vector, and a vector can be converted to a matrix by the reverse operation. For a vector corresponding to an FF beam, the phase may be linear, e.g., meaning that the phase progression throughout the vector is linear, wherein the phase corresponds to the phase of the complex numbers in the vector. A vector for which the phase is linear may, in short, be called a linear vector. An FF beam may also refer to a spatial domain basis vector (e.g., a spatial direction vector). An FF beam may refer to an FF basis beam. A linear vector used for precoding in a uniform linear array (ULA) may generate an FF beam. For other array geometries, other types of precoding vectors may generate an FF beam. An important example in practical systems is the uniform planar array (UPA). An UPA may be seen as an aggregation of multiple ULA, e.g., horizontal ULAs stacked vertically, or vertical ULAs stacked horizontally. Since a linear vector may generate an FF beam for a ULA, the aggregated linear vectors may generate an FF beam for the UPA including the corresponding aggregated ULAs. One way to describe an FF beam for a UPA is a matrix with dimensions corresponding to the number of horizontal and vertical antennas. Another, and equivalent, way to describe an FF beam for a UPA is a vector with a length corresponding to the number of horizontal and vertical antennas. In an example, the first part of the vector may correspond to the first horizontal row of antennas, the subsequent part of the vector may correspond to the second horizontal row of antennas, etc. In another example, the first part of the vector may correspond to the first vertical column of antennas, the subsequent part of the vector may correspond to the second vertical column of antennas, etc. A vector for a UPA may be described as a Kronecker product between two vectors (both either column vectors or row vectors). A vector corresponding to a FF beam for a UPA may be described as a Kronecker product between two linear vectors, wherein a first of the two vectors may correspond to a FF beam in a first, e.g., the horizontal, dimension and a second of the two vectors may correspond to a FF beam in a second, e.g., the vertical, dimension. Such a vector may be denoted a Kronecker vector herein. A Kronecker vector constructed from two linear vectors may be piece-wise linear, e.g., the Kronecker vector is linear in the first N elements, the second N elements, etc., wherein N is the length of one of the two linear vectors. The phase of the last of the first N elements and the phase of the first of the second N elements might not follow the linearity, etc., which is why the Kronecker vector may be described as piece-wise linear. A Kronecker vector may be piece-wise linear also if only one of the two vectors is linear, while the other is non-linear. Such a Kronecker vector may be useful if a UE is in the FF based on the array aperture of a first dimension, e.g., horizontal or vertical, but in the NF based on the array aperture of a second dimension, e.g., vertical or horizontal. The corresponding Kronecker vector may correspond to an FF beam in a first dimension and a NF beam in a second dimension. In this disclosure, also non-linear vectors are considered. In some cases, a piece-wise linear vector, e.g., a Kronecker vector, may be classified as non-linear, e.g., if it is constructed from a linear vector and a non-linear vector (that is not a Kronecker vector). In some cases, a piece-wise linear vector, e.g., a Kronecker vector, may be classified as not being non-linear, e.g., if it is constructed from two linear vectors. In one example, a first vector is a Kronecker product, i.e., a Kronecker vector, of a second vector and a single-element vector, which could alternatively be viewed as a scalar. The first vector would be linear if the second vector is linear, since the first vector would be equal to the second vector times the element of the single-element vector.

A codebook of FF beams may refer to a two-dimensional grid of FF beams where each FF beam may be associated with a beam index. Also, each FF beam may be associated with two indices where the first index may indicate a horizontal beam index and the second index may indicate a vertical beam index.

An example of an FF beam is DFT beam. Also, a codebook of FF beams may refer to a codebook of DFT beams where a codebook of DFT beams may include one or more orthogonal DFT beams and one or more oversampled DFT beams. One or more orthogonal DFT beams may correspond to columns in a DFT matrix.

A codebook of FF beams may refer to a codebook of FF beams for constructing NF beams.

A codebook of FF beams may refer to a codebook of FF beams for constructing a codebook of NF beams.

A codebook of FF beams may refer to a codebook for constructing NF beams.

Also, a codebook of FF beams may refer to a set of FF beams, e.g., a set of FF beams for constructing NF beams or a codebook of NF beams.

Also, a codebook of FF beams may refer to a set of FF beams, e.g., a set of FF beams for constructing FF beams.

An FF beam may correspond to a vector from a codebook of FF beams.

An FF beam may correspond to a codeword from a codebook of FF beams.

Selecting an FF beam may correspond to selecting a codeword in a configured codebook, e.g., codebook of FF beams, and selecting a vector in a configured codebook, e.g., codebook of FF beams.

### Subset of FF Beams

A subset of FF beams refers to one or more FF beams that are grouped together. A subset of FF beams may be associated with a certain angle range.

The UE may be configured with multiple subsets of FF beams where each subset is associated with a beam subset index.

Each included FF beam within a subset of FF beams is associated with one or more beam indices.

A subset of FF beams may refer to a subset of FF beams for constructing NF beams or codebook of NF beams, e.g., UE may be configured with one or more subsets of FF beams for constructing NF beams or codebook of NF beams (e.g., each subset of FF beams for constructing NF beams is associated with one or more subsets of beamfocusing parameters), a subset of FF beams associated with codebook subset restrictions (e.g., amplitude restrictions, cross-correlation restrictions), a subset of FF beams for constructing FF beams, and a combination thereof.

A set of FF beams may refer to a set of one or more subsets of FF beams for constructing NF beams or codebook of NF beams, a set of one or more subsets of FF beams for constructing FF beams, and a combination thereof.

NF Precoder with Per-FF Beam Beamfocusing Parameter

A NF precoder with per-FF beam beamfocusing parameter refers to a NF precoder including one or more NF beams constructed using separate beamfocusing parameters. In particular, each NF beam is constructed using an FF beam and a corresponding beamfocusing parameter.

A NF precoder with per-FF beam beamfocusing parameter may also refer to a NF precoder constructed through applying beamfocusing parameters on the FF beam level.

A NF precoder with per-FF beam beamfocusing parameter indicates a NF precoder with per-NF beam focus distance.

NF Precoder with Per Group of FF Beam Beamfocusing Parameter

A NF precoder with per group of FF beam beamfocusing parameter refers to a NF precoder including one or more NF beams where more than one NF beam may be constructed using the same beamfocusing parameter. In particular, a plurality of NF beams is constructed by grouping multiple FF beams and applying a common beamfocusing parameter to the grouped FF beams.

There may be multiple groups of FF beams where a common beamfocusing parameter is applied to each group and separate beamfocusing parameters are applied to different groups of FF beams.

The constructed NF beams from a group of FF beams are constructed using the same beamfocusing parameter. A NF precoder with per group of FF beam beamfocusing parameter may also refer to a NF precoder constructed through applying beamfocusing parameters on the FF precoder level, e.g., all selected FF beams are grouped together in one group and same beamfocusing parameter is applied to construct all NF beams within the NF precoder.

A NF precoder with per group of FF beam beamfocusing parameter indicates a NF precoder with per group of NF beams focus distance, e.g., one or more NF beams (a group of NF beams) are constructed considering same focus distance.

### Hybrid NF-FF Precoder

Hybrid NF-FF precoder refers to a precoder including a combination of NF and FF beams, e.g., where one or more beamfocusing parameters are applied to selected FF beams to construct one or more NF beams.

Hybrid NF-FF precoder may refer to a precoder including an FF precoder and a NF precoder, e.g., an FF precoder is added to a NF precoder to construct a hybrid NF-FF precoder.

Phase calculation function refers to the function used to calculate a phase correction factor as a function of a selected beamfocusing parameter. For instance, the phase calculation function may refer to a function based first order Taylor series approximation or a function based on second order Taylor series approximation, etc.

Layer-dependent beamfocusing parameters refers to a precoder for which the UE separately reports beamfocusing parameters for different transmission layers, e.g., the UE reports one or more beamfocusing parameters for each transmission layer.

Layer-independent beamfocusing parameters refers to a precoder for which the UE reports common beamfocusing parameters to be applied for all transmission layers.

Beams to be added refers to the one or more beams to be added (e.g., combined) together for precoder construction. Also, beams to be combined may refer to the beams to be added for precoder construction.

A precoder vector may for example correspond to a DFT beam in a codebook of DFT beams, a vector in a codebook of DFT beams, a vector in a codebook of FF beams, a FF beam in a codebook of FF beams, a vector in a codebook of basis beams, and a spatial domain basis vector.

A precoder can be constructed using one or more precoder vectors.

Inter-precoder interference:

This may indicate the interference (e.g., cross correlation) between a first precoder and a second precoder that may be used to construct a hybrid precoder.

### Intra-Precoder Interference

Intra-precoder interference may indicate the interference (e.g., cross correlation) between the beams (e.g., precoder vectors with/without phase correction vectors) that may be used to construct a precoder, e.g., a NF precoder.

### Inter-Transmission Layer Interference

Inter-transmission layer interference may indicate the interference between precoders for different transmission layers. For instance, in case of 2-layer based operation, inter-transmission layer interference indicates the interference between the precoder for the first transmission layer and the precoder for the second transmission layer.

Intra-precoder interference may correspond to inter-transmission layer interference since the same set of beams can be used for constructing the precoders for different transmission layers but with different scaling (e.g., co-phasing) factors.

New precoder may refer to a precoder for which the UE reports all the attributes describing the precoder. A new precoder may refer to a reported precoder that does not depend on a previously reported precoder attribute.

Updated precoder refers to a precoder for which the UE reports one or more parameters describing additional parameters to or change in attributes of a previously, e.g., the latest, determined and/or reported precoder. In case the updated precoder includes changes in one or more attributes to a previous precoder, the updated precoder attributes are referred to as updated attributes or new attributes.

Beam index may refer to a NF beam index or an FF beam index. For instance, beam index indicates a NF beams index to refer to a NF beam in a codebook of NF beams. The beam index may alternatively indicate an FF beam index to refer to an FF beam in, for example, a codebook of FF beams, a set of FF beams, or a subset of FF beams.

### Subset of Prohibited Beams

Subset of prohibited beams may refer to a subset of NF beams or a subset of FF beams that a UE cannot select beams from for precoder construction.

A subset of prohibited FF beams can indicate one or more FF beams that cannot be selected by a UE for precoder construction.

A subset of prohibited NF beams can indicate one or more NF beams (e.g., a NF beam may be indicated by a combination of an FF beam and a beamfocusing parameter) that cannot be selected by a UE for precoder construction.

A subset of prohibited NF beams may refer to a subset of FF beams and/or NF beams that a UE cannot select beams for precoder construction.

### Angle/Angle Range

Angle/Angle range may refer to the angle between the UE and a TRP, e.g., angle between the UE and a UPA in the TRP. In addition, it may refer to the angle, e.g., of a transmitted FF beam, from the TRP where each FF beam corresponds to a specific angle.

The angle may be measured with reference to a TRP reference direction based on orientation of the TRP's antenna array, e.g., UPA. For instance, the angle may be measured with reference to the bore sight of the UPA in a TRP.

The angle may represent a zenith/elevation angle an azimuth angle or both, e.g., a combination thereof.

The angle range refers to a range of angles which can be described, e.g., by a minimum angle and a maximum angle.

Distance/Distance range may refer to the distance between the UE and a TRP or the distance between a TRP and a scatterer. Distance range refers to a range of distances which can be described, e.g., by a minimum distance and a maximum distance.

Region may indicate a distance range (e.g., a maximum and/or minimum distance defining a distance range), an angle range (e.g., a maximum and/or minimum angle defining an angle range), or a combination thereof. A UE may be configured with different regions (e.g., zones) where each region is associated with region ID/index.

Scaling factor to a precoder may refer to a factor (e.g., real or complex value) that is applied to all beams constructing the precoder. Scaling factor to a precoder may be envisioned as the factor (e.g., real or complex value) to be applied to the strongest beam within a precoder.

### Configuration

Herein, the UE being “configured with” may refer to the scenario that the UE receives information indicative of a configuration (e.g., static, dynamic, semi-persistent) from the gNB or another node, e.g., using RRC signaling.

The UE being “configured” or “pre-configured” to perform an action may also refer to the UE being (hard-) coded to perform the action in compliance with one or more standard specifications.

### UE Configuration

### UE Configuration of FF Beams

In one embodiment, a UE is configured with two codebooks of FF beams where the UE may be configured to use a first codebook of FF beams to construct NF beams (e.g., a codebook of NF beams) and configured to use a second codebook of FF beams to construct FF beams.

In one embodiment, a UE is configured with a codebook of FF beams and two subsets of FF beams from the codebook of FF beams where each subset of FF beams is associated with a beam subset index. The UE may be configured to use a first subset of FF beams to construct NF beams (e.g., a codebook of NF beams) and be configured to use a second subset of FF beams to construct FF beams. For instance, the first and second subsets of FF beams may be overlapping (e.g., one or more FF beams may be included in the first and second subsets of FF beams). Alternatively, the first and second subsets of FF beams may be disjoint.

In one embodiment, a UE may be configured with one or more subsets of FF beams for constructing NF beams where each subset of FF beams is associated with a beam subset index. There might be an association between one or more subsets of FF beams for constructing NF beams and one or more configured subsets of beamfocusing parameters.

The one or more configured subsets of FF beams for constructing NF beams may belong to a configured codebook of FF beams for constructing NF beams. The one or more configured subsets of FF beams for constructing NF beams may belong to a larger configured set/subset of FF beams for constructing NF beams. The configured one or more subsets of FF beams for constructing NF beams may belong to a configured codebook of FF beams.

A set/subset of FF beams for constructing NF beams may include orthogonal FF beams. Alternatively, a set/subset of FF beams for constructing NF beams may include both orthogonal FF beams and non-orthogonal FF beams (e.g., oversampled DFT beams).

### UE Configurations of Beamfocusing Parameters

In an embodiment, a UE may be configured with one or more subsets of beamfocusing parameters, where each subset includes one or more beamfocusing parameters. Each subset of beamfocusing parameters is associated with a parameter subset index.

In a first example, the UE may be configured with an association between configured subsets of beamfocusing parameters and different angular directions from the NW. For instance, the UE may be configured with an association between one or more configured subset of FF beams (e.g., one or more configured subset of FF beams used for constructing NF beams where each subset includes one or more FF beams) and one or more subsets of beamfocusing parameters. The UE may also be configured with an association between a configured angle range (e.g., a range defined by a minimum and maximum angles, e.g., through sampling of the angular domain, etc.) and one or more subsets of beamfocusing parameters.

In a second example, the UE may be configured with an association between configured subsets of beamfocusing parameters and different configured regions in the cell (e.g., region-based subsets of beamfocusing parameters). For instance, the UE may be configured with an association between a configured region (e.g., a region defined by a minimum and maximum distances and minimum and maximum angles, e.g., through sampling of distance and angular domains, etc., where a region may be associated with a DL RS) and one or more subsets of beamfocusing parameters

In an embodiment, the UE may be configured with one or more parameters for constructing one or more subsets of beamfocusing parameters. For instance, the UE may be configured with one or more of: one or more parameters indicating one or more possible minimum beamfocusing parameters, one or more parameters indicating one or more possible maximum beamfocusing parameters, one or more parameters (e.g., integer values) indicating one or more possible quantization levels of beamfocusing parameters, and one or more parameters (e.g., integer values) indicating one or more possible number of bits for beamfocusing parameters quantization

In addition, the UE may be configured with an association between configured parameters for constructing subsets of beamfocusing parameters and different angular directions from the NW or configured regions (e.g., UE may be configured with one or more parameters for constructing subsets of beamfocusing parameters for different angular directions or different configured regions where a configured region may be defined by a distance range and/or angle range). For instance, the UE may be configured to construct one or more region-based subsets of beamfocusing parameters using the region-based configured parameters for constructing a subset of beamfocusing parameters, or be configured to construct one or more angle-based subsets of beamfocusing parameters using the angle-specific configured parameters for constructing a subset of beamfocusing parameters.

### UE Configurations of Reporting Parameters for Different Precoder Types

The UE may be configured to report different parameters describing attributes of a determined precoder based on the configured precoder type.

A UE may be configured to report parameters, e.g., if UE is configured with a precoder type set to “NF precoder with per-FF beam beamfocusing parameter”. These parameters can include one or more of selected FF beams for constructing NF beams, selected subset(s) of beamfocusing parameters, selected beamfocusing parameters for constructing NF beams, association between selected FF beams and selected subsets of beamfocusing parameters, association between selected FF beams and selected beamfocusing parameters, association between beamfocusing parameters and transmission layers e.g., in case layer-dependent reporting of beamfocusing parameters is configured into UE, and indication for applied phase calculation function for precoder determination

A UE may be configured to report one or more of the following parameters, e.g., if UE is configured with a precoder type set to “NF precoder with per group of FF beams beamfocusing parameter”: selected FF beams for constructing NF beams, number of groups of FF beams, indicator for FF beams within each group of FF beams, selected beamfocusing parameters, selected subsets of beamfocusing parameters, association between groups of FF beams and beamfocusing parameters, association between groups of FF beams and subsets of beamfocusing parameters, association between subsets of beamfocusing parameters and transmission layers e.g., in case layer-dependent reporting of beamfocusing parameters is configured into UE, association between beamfocusing parameters and transmission layers e.g., in case layer-dependent reporting of beamfocusing parameters is configured into UE, and indication for applied phase calculation function for precoder determination.

A UE configured to report NF precoder with single group of FF beams may be configured to report one or more of selected FF beams for constructing NF beams, selected subset(s) of beamfocusing parameters, selected beamfocusing parameter(s), association between beamfocusing parameters and transmission layers e.g., in case layer-dependent reporting of beamfocusing parameters is configured into UE, association between subsets of beamfocusing parameters and transmission layers e.g., in case layer-dependent reporting of beamfocusing parameters is configured into UE, and indication for applied phase calculation function for precoder determination

A UE may be configured to report one or more of the following parameters, e.g., if UE is configured with a precoder type set to “hybrid NF-FF precoder”: selected FF beams, number of FF beams and/or NF beams, indication for selected FF beams for constructing NF beams, and indication of selected FF beams for which no beamfocusing parameters are applied.

For indicated selected FF beams for constructing NF beams, the UE reports one or more of indicator whether “per FF beam beamfocusing parameter” or “per group of FF beams beamfocusing parameter” is applied, and indication for applied phase calculation function for precoder determination.

In case the UE indicates per FF beam beamfocusing parameter, the UE reports one or more of selected subset of beamfocusing parameters, selected beamfocusing parameter(s), association between selected FF beams for constructing NF beams and beamfocusing parameters, association between selected FF beams for constructing NF beams and subsets of beamfocusing parameters, and association between beamfocusing parameters and transmission layers, e.g., in case layer-dependent reporting of beamfocusing parameters is configured into UE.

In case the UE indicates per group of FF beams beamfocusing parameter, the UE reports one or more of number of groups of FF beams, indicator for FF beams within each group of FF beams, selected beamfocusing parameters, selected subsets of beamfocusing parameters, association between groups of FF beams and beamfocusing parameters, association between groups of FF beams and subsets of beamfocusing parameters, and association between beamfocusing parameters and transmission layers, e.g., in case layer-dependent reporting of beamfocusing parameters is configured into UE.

### UE Configurations for Determining Attributes of Certain Precoder Types

The content of a CSI report indicating a certain precoder attributes based on the precoder type may be impacted by one or more conditions. In particular, the UE can use measurements and the conditions/methods to determine whether to report different or common beamfocusing parameters for different transmission layers, determine the NF beams that can be combined together in a precoder, determine phase calculation function to be applied for precoder construction, determine the beams to be grouped together in a group of beams, and determine the beamfocusing parameter for a group of beams.

There are different embodiments when it comes to the NW indication of one or more parameters for precoder determination.

The UE may be configured with a parameter indicating whether to determine and report layer-dependent or layer-dependent beamfocusing parameter.

The UE may receive (e.g., be configured with) a binary variable indicating layer-dependent or layer-independent beamfocusing parameters. A configured binary parameter may be set to “0” to indicate layer-independent reporting of beamfocusing parameters whereas configured binary parameter may be set to “1” to indicate layer-dependent reporting of beamfocusing parameters.

The UE may receive (e.g., be configured with) a Boolean variable indicating layer-dependent or layer-independent beamfocusing parameters. A configured binary parameter may be set to “false” to indicate layer-independent reporting of beamfocusing parameters whereas configured binary parameter may be set to “true” to indicate layer-dependent reporting of beamfocusing parameters.

The UE may receive (e.g., be configured with) a string variable indicating layer-dependent or layer-independent beamfocusing parameters.

The UE may be configured with a parameter indicating the phase calculation function to be used for precoder determination. The phase calculation function can be based on a first order Taylor series approximation, on a second order Taylor series approximation, etc.

The UE may receive (e.g., be configured with) an index indicating a certain phase calculation function for precoder determination where each phase calculation function is associated with an index.

The UE may receive (e.g., be configured with) a bitmap indicating a certain phase calculation function for precoder determination. For instance, there might be an association between each bit within the received bitmap and different phase calculation functions.

The UE may receive (e.g., be configured with) a string variable indicating a certain phase calculation function for precoder determination.

The UE may be configured with a parameter indicating number of NF/FF beams in a hybrid NF-FF precoder. Additionally, the UE may be configured with the total number of beams (L), i.e., the sum of the number of NF beams and the number of FF beams, constructing the precoder. Moreover, the UE may receive (e.g., be configured with) a parameter (e.g., integer, ratio, etc.) indicating the number of NF and/or FF beams within the hybrid field precoder.

The UE may be configured with a parameter indicating a number of group of FF beams in case UE is configured with a precoder type “NF precoder with group of FF beams beamfocusing parameter”. The UE may be configured with a number of group of FF beams for constructing NF precoder.

The UE may receive one or more of parameters described herein for precoder determination either through RRC configurations, MAC CE, DCI, etc.

The UE may be configured with one or more scaling factors for a hybrid NF-FF precoder. For instance, a pair of scaling factor where the first scaling factor indicates the scaling factor for a first precoder (e.g., FF precoder) and the second scaling factor indicates the scaling factor for a second precoder (e.g., NF precoder), or a single scaling factor where the scaling factor may be associated with a first precoder (e.g., FF precoder) or associated with a second precoder (e.g., NF precoder). For example, the scaling factor for one of the precoders is assumed to be 1, while the scaling factor for the other precoder is configured, e.g., to a value less than or equal to 1. The configuration may also indicate for which of the precoders, e.g., the FF precoder or the NF precoder, the configured scaling factor is applicable, e.g., with a single bit field.

The UE may make measurements for determining one or more contents of certain precoder types. In particular, the UE may be configured to perform measurements to determine the beams (NF beams and/or FF beams) that can be combined to construct a precoder.

In an embodiment, the UE may be configured to perform one or more measurements to determine whether two or more beams can be combined to construct a precoder. For instance, the UE may be configured to determine the cross correction between a NF beam and another NF beam, the UE may be configured to determine the cross correction between a NF beam and a FF beam, and the UE may be configured to determine the absolute difference between a beamfocusing parameter used to construct a NF beam and a beamfocusing parameter used to construct another NF beam.

In another embodiment, the UE may be configured to determine the cross correlation between a determined beam (NF and/or FF beam) and one or more beams in a configured subset of prohibited beams.

The rationale for these measurements include that the UE may measure the cross correlation between candidate beams (NF beams and/or FF beams) for precoder construction to minimize the inter-transmission layer interference through ensuring that the cross correlation between the beams is minimized, and that the UE may measure the cross correlation between a candidate beam (NF beam or FF beam) for precoder construction and one or more beams (NF beams and/or FF beams) included in a subset of prohibited beams (e.g., NF beams and/or FF beams used for DL transmission for other existing UEs in the cell). Minimizing such cross correlation may limit the inter-UE interference and hence improve the per-user and overall system performance.

The UE may determine one or more contents of certain precoder types based on certain conditions or methods. In other words, the UE can determine one or more of precoder attributes based on certain conditions, and may use certain methods to determine required parameters describing the determined precoder. These methods can be used to determine the beams that can be grouped in case of NF precoder with per group of beams beamfocusing parameter. These methods can be used to determine the beamfocusing parameter for a group of beams.

The UE may be configured with one or more conditions for determining the number of NF beams in a hybrid NF-FF precoder. In an embodiment, the UE may be configured with one or more conditions for determining the number of NF beams in a NF-FF precoder. For instance, UE may be configured with conditions based on amplitude coefficients of FF beams. In one embodiment, the UE may be configured to determine the number of NF beams based on the determined amplitude coefficients of selected FF beams for constructing NF beams. For instance, the UE may be configured to determine the number of NF beams to be equal to the number of FF beams whose amplitude coefficients are above a configured threshold. The UE may then determine the beamfocusing parameters to be applied to FF beams whose amplitude coefficients are above a configured threshold.

The UE may be configured with one or more conditions for determining the beams to be combined for precoder construction. In an embodiment, the UE may be configured with one or more conditions for determining whether two or more beams (NF beams and/or FF beams) can be combined or not. For instance, UE may be configured with one or any combination of conditions based on cross correlation between beams and conditions based on an absolute difference between beamfocusing parameters of different beams.

### Conditions Based on Cross Correlation Between Beams

In one embodiment, the UE may be configured with one or more conditions for determining whether to combine two or more beams for precoder construction based on cross correlation between the beams. For instance, the UE may be configured with a threshold indicating the maximum cross correlation between beams to be combined for precoder construction. For example, the UE may combine two NF beams in case the cross correlation between the two beams is below a threshold, or the UE may combine a NF beam and an FF beam in case the cross correlation between the two beams is below a threshold.

The UE may be configured with one or more subsets of prohibited NF beams and one or more subsets of prohibited FF beams. In addition, for a configured subset of prohibited NF beams or a configured subset of prohibited FF beams, the UE may be configured with a threshold indicating a maximum cross correlation associated with it. The UE can be configured to select a beam (NF beam and/or FF beam) for precoder construction if the cross correlation between the beam (NF beam and/or FF beam) and one or more of NF beams in a configured subset of prohibited NF beams is below a threshold. The UE can be configured to select a beam (NF beam and/or FF beam) for precoder construction if the cross correlation between the beam (NF beam and/or FF beam) and one or more of FF beams in a configured subset of prohibited FF beams is below a threshold.

Alternatively, the UE may be configured with one or more subsets of prohibited beams (NF and/or FF beams). In addition, for a configured subset of prohibited beams, the UE may be configured with a threshold indicating a maximum cross correlation associated with it. The UE may select a beam (NF beam and/or FF beam) for precoder construction if, for example, the cross correlation between the beam (NF beam and/or FF beam) and one or more of NF beams and/or FF beams in a configured subset of prohibited NF beams is below a threshold.

### Conditions Based on Absolute Difference Between Beamfocusing Parameters of Different Beams

In one embodiment, the UE is configured with one or more conditions for determining whether to combine two or more beams for precoder construction based on the absolute difference between beamfocusing parameters of different beams. For instance, the UE may be configured with a threshold indicating the maximum absolute difference between beamfocusing parameters of different beams. For example, the UE may combine two NF beams in case the absolute difference between the applied beamfocusing parameters to construct the beams is below a configured threshold, or combine a NF beam and an FF beam in case the beamfocusing parameter used to construct the NF beam is below a threshold.

The UE may be configured with one or more methods for determining the beams to be grouped together in case the UE is configured with NF precoder with per group of FF beams beamfocusing parameter. In an embodiment, the UE is configured with one or more methods for determining the FF beams to be added in a group of FF beams in case of NF precoder with per group of FF beams beamfocusing parameter. For instance, UE may be configured with one or any combination of methods based on configurations of subsets of beamfocusing parameters associated with the FF beams, methods based on corresponding paths characteristics of FF beams, methods based on amplitude coefficients of FF beams, and methods based on configured angle ranges.

Methods Based on Configurations of Subsets of Beamfocusing Parameters Associated with the FF Beams

In one embodiment, the UE is configured to group FF beams that are associated with same subset(s) of beamfocusing parameters. Since a common beamfocusing parameter is applied to different FF beams belonging to same group of FF beams, it might be beneficial to group FF beams that are associated with the same subset of beamfocusing parameters.

### Methods Based on Corresponding Paths Characteristics of FF Beams

In one embodiment, UE may be configured to group FF beams corresponding to NLoS paths. The UE may determine the strongest FF beam and may classify all selected FF beams other than the strongest FF beam to correspond to NLoS paths. Due to the dominant contribution of the LoS path over the NLoS path, the UE can group FF beams corresponding to NLoS path into a single group and apply a common beamfocusing parameter to them, which can reduce signaling overhead.

### Methods Based on Amplitude Coefficients of FF Beams

In one embodiment, UE may be configured to group FF beams whose amplitude coefficients falls within a configured range of amplitude coefficients (e.g., one or more amplitude coefficients) or that have the same amplitude coefficients.

### Methods Based on Configured Angle Ranges

In one embodiment, the UE may be configured with different angle ranges. The UE may be configured to group FF beams whose corresponding angles belong to same angle range.

The UE may be configured with one or more methods for determining the beamfocusing parameter for a group of FF beams in case UE is configured with a NF precoder with per group of FF beams beamfocusing parameter.

In one embodiment, the UE is configured to select a beamfocusing parameter for a group of FF beams from a region-based configured subset of beamfocusing parameters. For example, the UE may be configured with one or more region-based subsets of beamfocusing parameters. The UE may be configured to select a beamfocusing parameter for a group of FF beams from a configured region-based subset of beamfocusing parameters (e.g., UE determines a region and selects a beamfocusing parameter from a subset associated with the determined region). For example, in case UE is configured with layer-dependent beamfocusing parameters, UE may be configured to select the beamfocusing parameters for different layers from a configured region-based subset of beamfocusing parameters (e.g., UE determines a region and selects a beamfocusing parameter from a subset associated with the determined region).

In one embodiment, the UE is configured to select a beamfocusing parameter for a group of FF beams from subset of beamfocusing parameters associated with the strongest FF beam in the group of FF beams. For example, the UE may be configured with one or more subsets of beamfocusing parameters associated with FF beams (e.g., associated with subsets of FF beams). The UE may be configured to select a beamfocusing parameter for a group of FF beams from a configured subset of beamfocusing parameters associated with the strongest FF beam in the group of FF beams. For example, in case UE is configured with layer-dependent beamfocusing parameters, the UE may be configured to select the beamfocusing parameters for different layers from a configured subset of beamfocusing parameters associated with the strongest FF beam in each layer.

In one embodiment, the UE is configured to select a beamfocusing parameter for a group of FF beams from one or more subsets of beamfocusing parameters associated with FF beams within a group of FF beams. For example, different FF beams with a group of FF beams may be associated with different subsets of beamfocusing parameters and the UE may be configured to select a beamfocusing parameter for a group of FF beams from all subsets of beamfocusing parameters associated with FF beams within the group of FF beams. For example, in case the UE is configured with layer-dependent beamfocusing parameters, the UE may be configured to select the beamfocusing parameters for different layers from all subsets of beamfocusing parameters associated with FF beams within the group of FF beams.

The UE may be configured with one or more methods for determining a hybrid NF-FF precoder. In an embodiment, the UE may be configured to construct a hybrid NF precoder as a precoder including two separate precoders, for instance, a first precoder (e.g., FF precoder) and a second precoder (e.g., NF precoder) or as a precoder including one or more NF beams and one or more FF beams. Additionally, the UE may be configured to use one or more beam (e.g., FF beams) from a first codebook (e.g., codebook of FF beams) to determine a first precoder (e.g., FF precoder) and a second precoder (e.g., NF precoder) or to determine both FF beams and NF beams constructing the precoder.

### UE Configurations for Reporting an Updated or New Precoder

The UE can use different configurations and conditions to determine whether to send an update to the latest reported precoder attributes or to send a new report.

### NW Configurations for Reporting Updated or New Precoder

The UE may be configured with different configurations for reporting updated or new precoder.

When it comes to CSI report configurations with different periodicity, in an embodiment, the UE is configured with different configurations for reporting updated or new precoder. For instance, the UE may be configured with one or more CSI report configurations (e.g., semi-persistent, periodic CSI configurations) with different periodicities for reporting an updated or new precoder. For example, the UE may be configured with a CSI report with low periodicity (high frequency of CSI reporting) for reporting an updated precoder, or with a CSI report with high periodicity (low frequency of CSI reporting) for reporting a new precoder. The UE may report an updated precoder more frequently than reporting a new precoder since reporting a new report may cause higher signaling overhead compared to reporting an updated precoder.

When it comes to NW triggering of updated or new CSI reporting, in an embodiment, the UE is configured with association between one or more aperiodic CSI report configurations and reporting updated or new precoder. The UE may receive aperiodic triggering from the NW indicating reporting a new or updated precoder. For instance, the UE may receive aperiodic triggering indicating activation of a CSI report associated with reporting an updated precoder, or receive aperiodic triggering indicating activation of a CSI report associated with reporting a new precoder. In an embodiment, the UE may be configured to report an updated precoder over physical uplink control channel (PUCCH) and report a new precoder over physical uplink shared channel (PUSCH).

UE may be configured with variable indicating reporting updated or new precoder. In an embodiment, the UE may be configured with a CSI report configuration and a variable (binary, Boolean, string variable) indicating whether it reports updated or new precoder. For instance, the UE may receive a binary value for the configured variable indicating whether it reports updated or new precoder (for instance, the UE may be configured to report a new precoder if the value of configured variable is set to “1” while the UE may be configured to report an updated precoder if the value of configured variable is set to “0”), receive a Boolean value for the configured variable indicating whether it reports updated or new precoder (for instance, the UE may be configured to report a new precoder if the value of configured variable is set to “true” while the UE may be configured to report an updated precoder if the value of configured variable is set to “false”), or receive a string value for the configured variable indicating whether it reports updated or new precoder (for instance, the UE may be configured to report a new precoder if the value of configured variable is set to “New” while the UE may be configured to report an updated precoder if the value of configured variable is set to “Update”). The UE may receive one or more of above-described parameters for reporting updated or new precoder either through RRC configurations, MAC CE, DCI, etc.

### Measurements for Determining Updated or New Precoder

The UE may perform measurements to determine whether to report updated or new precoder, e.g., the UE can compare the new precoder and the previous precoder, and the UE can measure elapsed time since the latest reported precoder.

The UE may be configured with one or more measurements for determination of reporting updated or new precoder. In an embodiment, the UE is configured to perform one or more measurements to determine whether to report updated or new precoder. For instance, the UE may be configured to one or any combination of compare the new precoder and the previous precoder and measure elapsed time since the latest reported precoder.

For the difference between a new and a previous precoder, in an embodiment, the UE is configured to determine the difference between a current determined precoder and a previous precoder (e.g., latest reported precoder). The UE may be configured to determine a precoder and compare the determined precoder and the latest determined and reported precoder. The latest determined and reported precoder may refer to a new precoder that has been determine and reported, the latest determined and reported precoder may refer to a determined precoder based on which an update has been reported, and the latest determined and reported precoder may refer to an updated precoder that has been determined and based on which an update has been reported.

For time elapsed since reporting latest new precoder, in one embodiment, the UE is configured to measure the time elapsed since reporting latest new precoder, e.g., the UE measures the time (e.g., in milliseconds, number of time slots, number of symbols, etc.) since it reported the latest new precoder, i.e., the precoder for which all attributes of determined precoder have been reported.

### Conditions for Determining Updated or New Precoder

The UE can determine whether to report an updated or a new precoder in different ways.

For example, the UE can report an updated precoder if the previous and the new precoders share the same beamfocusing parameters, share the same FF beams, share one or more beamfocusing parameters and/or FF beams, etc., the UE can report an updated precoder if the time elapsed since the last reported new precoder is below a threshold, and the UE can report an updated precoder in case the distance the UE moved in the detected region is below a threshold.

To this end, the UE may be configured with one or more conditions for determination of reporting updated or new precoder.

In an embodiment, the UE is configured with one or more conditions for determining whether to report updated or new precoder. For instance, the UE may be configured with one or any combination of conditions based on comparison between a new and a previous precoder, conditions based on time elapsed since reporting the latest precoder, and conditions based on performance differences between updated and new precoder.

For conditions based on comparison between a new and a previous precoder, in an embodiment, the UE may be configured with one or more conditions for determining whether to report updated or new precoder based on performed comparison between a current precoder and a previous precoder. For instance, the UE may be configured to report one or any combination of an updated precoder if the previous and current precoder has the same type, a new precoder if the previous and current precoder has different types, an updated precoder if the number of different FF beams between the current and previous precoder is below a threshold, a new precoder if the number of different FF beams between the current and previous precoder is above a threshold, an updated precoder if the current and previous precoder shares the same FF beams but have one or more different beamfocusing parameters, an updated precoder if the current and previous precoder shares the same beamfocusing parameters but have one or more different FF beams, an updated precoder if the number of beams with different FF beams and/or beamfocusing parameters between the current and previous precoder is below a threshold, and a new precoder if the number of beams with different FF beams and/or beamfocusing parameters between the current and previous precoder is above a threshold.

For conditions based on time elapsed since reporting latest new precoder, in an embodiment, the UE may be configured with one or more conditions for determining whether to report updated or new precoder based on time elapsed since reporting latest new precoder. For instance, the UE may be configured to report a new precoder if time elapsed since reporting latest new precoder is above a threshold or to report an updated precoder if time elapsed since reporting latest new precoder is below a threshold.

As elapsed time since reporting latest new precoder increases, the change in the UE surrounding conditions becomes more significant. Thus, in case of a small (i.e. below a threshold value) elapsed time since reporting latest new precoder, the UE can report an updated precoder as the current precoder may be highly correlated with the previous one, which can significantly reduce the overhead while maintaining a good performance for the UE. However, in case of large (i.e. above the threshold value) elapsed time after reporting latest new precoder, it can be preferred to report a new precoder as reporting an updated precoder may lead to a little save in signaling overhead but may harm the UE performance.

For conditions based on performance difference between updated and new precoder, in an embodiment, the UE may be configured with one or more conditions for determining whether to report updated or new precoder based on comparison between one or more performance metrics (e.g., CQI, spectral efficiency, SINR, etc.) between updated and new precoder. For instance, the UE can report a new precoder if the difference between a performance metrics of updated and new precoder is above a corresponding threshold, or report an updated precoder if the difference between one or more performance metrics of updated and new precoder is below a corresponding threshold.

One way to determine whether to report updated or new precoder is based on the trade-off between the achievable gain in the reduction of signaling overhead and the performance loss due to reporting updated precoder rather than new precoder. Thus, in case of a small or negligible performance loss (below a threshold), the UE can report an updated precoder to reduce the signaling overhead.

### UE Configurations of Reporting Updated Precoders

Different formats can be used to send an updated precoder for different types of precoder. For instance, for each precoder type, the UE may be configured to update and report one or more parameters indicating how the latest reported precoder attributes are updated. The different reporting formats for an updated precoder include reporting updated FF beams, updated beamfocusing parameters, updated NF beams (updating both FF beams and corresponding beamfocusing parameters), and additional information (e.g., report additional beamfocusing parameters, report additional FF beam and/or beamfocusing parameter, etc.).

To this end, the UE may be configured with one or more formats for reporting an updated precoder. In an embodiment, the UE may be configured with one or more formats for reporting an updated precoder. For instance, the different formats may include one or any combination of reporting an updated strongest FF beam, reporting an updated beamfocusing parameter associated with strongest FF beam, reporting an updated strongest NF beam, reporting one or more updated FF beams, reporting one or more updated beamfocusing parameters, reporting one or more updated NF beams, reporting one or more updated group of FF beams, and reporting additional parameters (e.g., reporting one or more additional FF beams, reporting one or more additional beamfocusing parameters, reporting one or more additional NF beams, and reporting one or more additional group of beams).

The UE may be configured with different CSI report configurations (e.g., CSI configurations with different periodicity) or the same CSI report configurations for reporting updated precoder with different formats (e.g., UE may be configured with association between different CSI report configurations and different formats for reporting updated precoder)

The UE may be configured with different reporting parameters for different reporting formats of an updated precoder.

In an embodiment, the UE is configured with association between the different formats for reporting an updated precoder and different reporting parameters. The UE may be configured to report one FF beam indicating a new strongest FF beam in case the UE is configured with updated precoder report format “reporting an updated strongest FF beam”. The UE may be configured to report one FF beam and its associated beamfocusing parameter indicating a new strongest NF beam in case the UE is configured with updated precoder report format “updated strongest NF beam”. The UE may be configured to report one beamfocusing parameter indicating a new beamfocusing parameter associated with strongest FF beam in case the UE is configured with updated precoder report format “reporting an updated beamfocusing parameter associated with strongest FF beam”. In case the UE is configured with updated precoder report format “reporting one or more updated FF beams”, it may be configured to report one or more of FF beams to be changed/updated in previous precoder, new FF beams, and association between FF beams to be changed/updated and new FF beams. In case the UE is configured with updated precoder report format “reporting one or more updated beamfocusing parameters”, it may be configured to report one or more of beamfocusing parameters to be changed/updated in previous precoder, new beamfocusing parameters beamfocusing parameters, and association between beamfocusing parameters to be changed/updated and new beamfocusing parameters. In case the UE is configured with updated precoder report format “reporting one or more updated NF beams”, it may be configured to report one or more of NF beams to be changed/updated in previous precoder (e.g., FF beams associated with the NF beams to be changed/updated in previous precoder and/or beamfocusing parameters associated with the NF beams to be changed/updated in previous precoder) and new beamfocusing parameters (e.g., new FF beams, new beamfocusing parameters, and association between new FF beams and beamfocusing parameters). In case the UE is configured with updated precoder report format “reporting one or more updated group of FF beams”, may be configured to report one or more of groups of FF beams to be updated in previous precoder, FF beams to be updated from the groups of FF beams, new FF beams, and association between new FF beams and groups of FF beams to be updated. In case the UE is configured with updated precoder report format “reporting one or more additional FF beams”, it may be configured to report one or more of additional FF beams, association between additional FF beams and a previously reported group of FF beams, and association between additional FF beams and a previously reported beamfocusing parameter. In case the UE is configured with updated precoder report format “reporting one or more additional beamfocusing parameters”, it may be configured to report one or more of additional beamfocusing parameters, additional groups of FF beams, association between additional beamfocusing parameter and a previously reported FF beam, and association between additional beamfocusing parameter and additional groups of FF beams. In case UE is configured with updated precoder report format “reporting one or more additional NF beams”, it may be configured to report one or more of one or more additional beamfocusing parameters, one or more additional FF beams, and association between additional FF beams and additional beamfocusing parameters. In case the UE is configured with updated report format “reporting one or more additional groups of FF beams”, it may be configured to report one or more of additional groups of FF beams, additional FF beams, additional beamfocusing parameters, association between additional beamfocusing parameter and additional groups of FF beams, and association between additional FF beams and additional groups of FF beams.

### UE Determination of Content of CSI Report for Different Precoder Types

The UE can determine the content of CSI report for different precoder types, including fixed content (e.g., as per configurations) and conditional content (e.g., layer-dependent reporting of beamfocusing parameters).

The UE may for example determine the content of a CSI report based on configured reporting parameters for different precoder types, configured measurements and conditions at the UE for determining the content, configured methods for determining beams within each group of beams in case of NF precoder with per group of beams beamfocusing parameter, and configured methods for determining beamfocusing parameter for a certain group of beams.

### UE Determination of CSI Report Content Based on Configuration

A UE may determine to report layer-dependent or layer-independent beamfocusing parameters based on its configuration. The UE may determine phase calculation functions for beam focusing parameter determination based on its configuration, e.g., phase calculation function based on first order Taylor series approximation, phase calculation function based on second order Taylor series approximation, etc. The UE may determine the number of NF beams and/or FF beams in a “hybrid NF-FF precoder” based on its configuration. The UE may determine the number of groups of FF beams based on its configuration. The UE may determine a hybrid NF-FF precoder based on configurations, for instance, UE may determine a hybrid NF-FF precoder through determining a precoder including two separate precoders, for instance, a first precoder (e.g., FF precoder) and a second precoder (e.g., NF precoder), or a precoder including one or more NF beams and one or more FF beams.

### UE Measurements for Determining Precoder Attributes

In an embodiment, the UE performs one or more measurements, based on which the UE may determine the number of NF beams in a hybrid NF-FF precoder. For instance, the UE may determine the amplitude coefficients of all selected FF beams (FF beams and FF beam for constructing NF beams) for precoder construction.

In an embodiment, the UE may perform one or more measurements, based on which the UE may determine whether two or more beams can be added together to construct a precoder. For instance, the UE may determine the cross correction between a candidate NF beam and another candidate NF beam for precoder construction, the UE may determine the cross correction between a candidate NF beam and a candidate FF beam for precoder construction, the UE may determine the absolute difference between a beamfocusing parameter used to construct a candidate NF beam and a beamfocusing parameter used to construct another candidate NF beam, and the UE may determine the cross correlation between a candidate beam (NF and/or FF beam) for precoder construction and one or more beams in a configured subset of prohibited beams.

In an embodiment, for a hybrid NF-FF precoder, the UE may perform one or more CSI-RS measurements to determine one or more scaling factors for constructing a hybrid NF-FF precoder.

### UE Determination of CSI Report Content Based on Conditions and UE Measurements

In an embodiment, the UE is configured with one or more conditions for determining the number of NF beams in a NF-FF precoder. For instance, the UE may determine the number of NF beams in a hybrid NF-FF precoder based on the amplitude coefficients of all selected FF beams constructing the precoder and a preconfigured threshold, e.g., number of NF beams is equal to number of FF beams with amplitude coefficients above a threshold.

In an embodiment, the UE may determine whether two or more beams can be combined or not, e.g., if they can be included in the same layer or the same precoder.

In an embodiment, the UE may determine whether to combine two or more beams for precoder construction based on cross correlation between the beams. For instance, the determination may be based on a threshold indicating the maximum cross correlation between the beams to be combined for precoder construction, for example, the UE may combine two NF beams in case the cross correlation between the two beams is below a threshold, or combine a NF beam and a FF beam in case the cross correlation between the two beams is below a threshold.

This condition increases the probability of combining/adding orthogonal beams (quasi-orthogonal beams where the cross correlation between the beams is small) for constructing the precoder. In turn, this can limit the interference between different transmission layers and improves the performance of the constructed precoder, e.g., improve the achievable SINR, spectral efficiency, etc.

In an embodiment, the UE may determine whether to combine two or more beams for precoder construction based on the absolute difference between beamfocusing parameters of different beams. For instance, the determination may be based on a threshold indicating the maximum absolute difference between beamfocusing parameters of different beams, for example, the UE may combine two NF beams in case the absolute difference between the applied beamfocusing parameters to construct the beams is below a configured threshold value, or combine a NF beam and a FF beam in case the beamfocusing parameter used to construct the NF beam is below a threshold value.

In an embodiment, the UE determines whether to select a NF beam or an FF beam for precoder construction based on the cross correlation between this beam and beams (NF beams and/or FF beams) included in a subset of prohibited beams. For instance, the UE may select a beam (NF beam and/or FF beam) for precoder construction if the cross correlation between the beam (NF beam and/or FF beam) and one or more of NF beams and/or FF beams in a configured subset of prohibited NF beams is below a threshold value.

This can help to limit the inter-UE interference when the UE determines a precoder that might be used by a TRP for DL transmission. For instance, subsets of prohibited beams may indicate the beams used for DL transmission for one or more existing UEs in the cell. Then, reducing the cross-correlation between the selected beams by the UE for precoder construction and subsets of prohibited beams minimizes the inter-UE interference and hence improves the performance in the cell, e.g., leads to higher spectral efficiency, etc.

### UE Determination of CSI Report Content Based on Configured Methods

In an embodiment, the UE may determine the FF beams to be combined in a group of FF beams in case of NF precoder with per group of FF beams beamfocusing parameter based on one or more configured methods. For example, the UE may determine to group FF beams that are associated with same subset(s) of beamfocusing parameters, group FF beams based on different angle ranges (e.g., FF beams whose corresponding angles belong to same angle range), group FF beams corresponding to NLoS paths, and group one or more FF beams whose amplitude coefficients falls within a configured range.

In an embodiment, the UE may determine the beamfocusing parameter for a group of FF beam based on one or more configured methods.

The UE may select a beamfocusing parameter for a group of FF beams from a region-based configured subset of beamfocusing parameters. For example, the UE may select a beamfocusing parameter for a group of FF beams from a configured region-based subset of beamfocusing parameters (e.g., UE determines a region and selects a beamfocusing parameter from a subset associated with the determined region). For example, in case the UE is configured with layer-dependent beamfocusing parameters, the UE may select the beamfocusing parameters for different layers from a configured region-based subset of beamfocusing parameters (e.g., the UE determines a region and selects a beamfocusing parameter from a subset associated with the determined region).

UE may detect a region in different ways. The UE can determine a distance between the UE and a TRP (e.g., the UE may detect a region associated with a distance range to which the determined distance belongs (e.g., UE may determine a distance based on measurement(s) on RS(s), UE positioning, UE sensing of the environment, etc.)), the UE can determine an angle between the UE and a TRP (e.g., the UE may detect a region associated with an angle range to which the determined angle belongs (e.g., the UE may determine angle based on measurement(s) on RS(s), UE positioning, UE sensing or the environment, etc.)), and the UE can measure one or more DL RS (e.g., the UE may be configured with association with different regions and one or more DL RSs. The UE may receive one or more DL RS associated with different regions (e.g., region IDs). The UE may measure the different received DL RSs and detect its region ID based on the measured DL RS with highest one or more metrics, e.g., RSRP, SINR, etc.)

In an embodiment, the UE may select a beamfocusing parameter for a group of FF beams from subset of beamfocusing parameters associated with the strongest FF beam in the group of FF beams. For example, the UE may select a beamfocusing parameter for a group of FF beams from a configured subset of beamfocusing parameters associated with the strongest FF beam in the group of FF beams. For example, in case UE is configured with layer-dependent beamfocusing parameters, the UE may select the beamfocusing parameters for different layers from a subset of beamfocusing parameters associated with the strongest FF beam in each layer.

In an embodiment, the UE may select a beamfocusing parameter for a group of FF beams from one or more subsets of beamfocusing parameters associated with FF beams within a group of FF beams. For example, different FF beams with a group of FF beams may be associated with different subsets of beamfocusing parameters, and the UE may select a beamfocusing parameter for a group of FF beams from all subsets of beamfocusing parameters associated with FF beams within the group of FF beams. For example, in case the UE is configured with layer-dependent beamfocusing parameters, the UE may select the beamfocusing parameters for different layers from all subsets of beamfocusing parameters associated with FF beams within the group of FF beams.

### UE Determination of Precoder

The UE may determine a set of parameters, etc., that are used to construct a precoder, and/or that may be included in a CSI report, e.g., as has been described. The UE may for example construct a precoder based on the equation

$${W}_{N F}^{l} = {ϵ}_{l} {\sum }_{i = 0}^{L - 1} {w}_{i , l} ( {v}^{( i )} ⊙ {b}^{( i )} ( {c}_{i} ) ) ,$$

The UE may determine the set of parameters such that a metric is optimized, e.g., maximized or minimized, wherein the metric may be hypothetical based on an estimated channel matrix, etc. The UE may determine the parameters such that a metric is above or below a threshold, e.g., a threshold based on quality-of-service requirements, such as a communication error rate. The UE may determine the set of parameters such that one or more metric(s) are optimized, under one or more constraints based on other metric(s).

For example, the UE may determine the set of parameters such that an estimated or predicted performance (e.g., in terms of spectral efficiency, data rate, modulation and coding scheme, channel quality indicator, channel capacity, etc.) is maximized. In an example, the UE may determine the set of parameters such that the performance is maximized while keeping an estimated or predicted error rate, e.g., block error rate or bit error rate, below a threshold value.

### UE Reporting of Constructed Precoder

### UE Reporting of Indication to Applied Phase Calculation Function for Precoder Determination.

To indicate the phase calculation function applied for precoder construction, the UE may report one or any combination of an index representing which phase calculation function is applied where different phase calculation functions are associated with different indices, a bitmap indicating a phase calculation function for precoder determination (for instance, there might be association between each bit within the received bitmap and different phase calculation functions where a bit “O” indicates that a phase calculation function is not applied while a bit “1” indicates that a phase calculation function is not applied), and a string variable indicating applied phase calculation function for precoder determination.

### UE Reporting of Indication of Whether Layer-Dependent/Independent Beamfocusing Parameters are Reported

To indicate whether layer-dependent or layer-independent beamfocusing parameters are reported, the UE may report one or any combination of a binary variable indicating layer-dependent or layer-independent beamfocusing parameters (for instance, the UE may report “0” to indicate layer-independent reporting of beamfocusing parameters and “1” to indicate layer-dependent reporting of beamfocusing parameters), a Boolean variable indicating layer-dependent or layer-independent beamfocusing parameters (for instance, UE may report “false” to indicate layer-independent reporting of beamfocusing parameters and “true” to indicate layer-dependent reporting of beamfocusing parameters), and a string variable indicating layer-dependent or layer-independent beamfocusing parameters.

### UE Reporting of Selected FF Beams

To indicate one or more selected FF beams, the UE may report one or any combination of beam indices of selected FF beams (e.g., from a configured codebook of FF beams, where the beam index of a FF beam may be indicated through a beam index representing the FF beam index (e.g., in the codebook of FF beams and two beam indices where the first and second beam indices representing the horizontal and vertical beam indices associated with the selected FF beam), an integer value indicating one or more selected FF beams (for instance, the UE may apply a configured algorithm that convert the indices of selected FF beams to an integer value), beam subset indices of subsets of FF beams to which selected FF beams belong, local beam indices of FF beams within their corresponding subsets of FF beams, and association between local beam indices and beam subset indices.

### UE Reporting of Number of NF Beams or FF Beams in a Hybrid NF-FF Precoder

To indicate the number of NF beams or number of FF beams in a hybrid NF-FF precoder, the UE may report one or any combination of an integer indicating total number of beams constructing the hybrid NF-FF precoder, an integer indicating number of NF beams in a hybrid NF-FF precoder, an integer indicating number of FF beams in a hybrid NF-FF precoder, a ratio indicating number of NF beams to the total number of beams (e.g., index to a configured ratio), and a ratio indicating number of FF beams to the total number of beams (e.g., index to a configured ratio).

UE Reporting of Indication to FF Beams to which Beamfocusing Parameters are/are not Applied

To indicate FF beams to which beamfocusing parameters are/are not applied, the UE may report one or any combination of a bitmap indicating whether a beamfocusing parameter is applied to an FF beam or not (e.g., the UE may send a bitmap with number of bits equal to the number of reported FF beams where a bit “0” indicates that no beamfocusing parameter is applied to a FF beam and a bit “1” indicates that a beamfocusing parameter is applied, e.g., FF beams used to construct NF beams, where a first and second bit in the bitmap indicates whether a beamfocusing parameter is applied to a first and second FF beam, respectively, and so on) and one or more sets of selected FF beams, e.g., where a first and second set indicate selected FF beams to which a beamfocusing parameter are not applied and selected FF beams to which a beamfocusing parameter are applied (e.g., FF beams used to construct NF beams), respectively. Each set may include one or more of global beam indices of one or more FF beams, local beam indices of one or more FF beams, beam subset indices of subsets of FF beams to which selected FF beams belong, beam indices of one or more reported FF beams, and association between local beam indices and beam subset indices.

### UE Reporting of Selected Subsets of Beamfocusing Parameters

To indicate one or more selected subsets of beamfocusing parameters, the UE may report one or any combination of an integer indicating number of selected subsets of beamfocusing parameters, one or more global parameter subset indices of selected subsets of beamfocusing parameters (e.g., a global parameter subset index indicates the indices of selected subsets of beamfocusing parameters from all configured subsets of beamfocusing parameters), one or more local parameter subset indices of selected subsets of beamfocusing parameters (e.g., a local parameter subset index may indicate the index of the subset of beamfocusing parameters from the different subsets of beamfocusing parameters associated with a FF beam, e.g., subsets of FF beams, or a local parameter subset index may indicate the index of the subset of beamfocusing parameters from the different subsets of beamfocusing parameters associated with a region), the region to which the subsets of beamfocusing parameters belong (for example, region index, the index of the DL RS associated with the region, the range index of the distance range associated with the region, the range index of the angle range associated with the region, and a combination of the range index of angle range and range index of distance range associated with the region), and the distance associated with the selected subset of beamfocusing parameters (for example, the distance index, the range index of the distance range, index of the upper bound distance of the distance range, and the index of the lower bound distance of the distance range).

In the case of layer-dependent beamfocusing parameters, the UE may report one or more of the described parameters per transmission layer. For instance, the UE may report one or more sets of selected subsets of beamfocusing parameters where a first set may include one or more selected subsets of beamfocusing parameters for a first transmission layer while a second set may include one or more selected subsets of beamfocusing parameters for a second transmission layer, and so on.

### UE Reporting of Association Between Selected FF Beams and Selected Subsets of Beamfocusing Parameters

To indicate association between reported FF beams and reported subsets of beamfocusing parameters, the UE may report one or any combination of FF beams and their associated subsets of beamfocusing parameters in the same order (e.g., for each transmission layer, where the order for reporting these parameters may be ascending order of beam indices of selected FF beams, descending order of beam indices of selected FF beams, ascending order of parameter subset indices of selected subsets of beamfocusing parameters, e.g., for a transmission layer, or descending order of parameter subset indices of selected subsets of beamfocusing parameters, e.g., for a transmission layer), different tuples of parameters (e.g., FF beam-parameter subset association tuple, where a FF beam-parameter subset association tuple may include one or any combination of one or more global FF beams indices, one or more local FF beams indices, one or more local parameter subsets indices of one or more local subsets of beamfocusing parameters, one or more global parameter subsets indices of one or more global subsets of beamfocusing parameters, integer value reflecting one or more global FF beams, integer value reflecting one or more local FF beams, one or more indices of reported FF beams, one or more indices of reported FF beams to which beamfocusing parameters are applied, indication for a transmission layer, and one or more sets of selected subset of beamfocusing parameters for different transmission layers

The parameters in each FF beam-parameter subset association tuple are logically connected (associated with each other). For example, a FF beam-parameter subset association tuple may include one or more local parameter subsets indices and one or more global FF beams indices, one or more global parameter subsets indices and one or more local FF beams indices, one or more global parameter subsets indices and one or more beams indices of reported FF beams, one or more global parameter subsets indices and one or more beams indices of reported FF beams, one or more global parameter subsets indices and one or more beams indices of reported FF beams to which beamfocusing parameters are applied, one or more local parameter subsets indices and an integer indicating one or more global FF beams, one or more global parameter subsets indices and an integer indicating one or more local FF beams, one or more global parameter subsets indices and an integer indicating one or more global FF beams, one or more global parameter subsets indices and one or more global FF beams indices, one or more global parameter subsets indices, transmission layer index, and one or more local FF beams indices, one or more global parameter subsets indices, transmission layer index, and one or more local FF beams indices, and one or more sets of selected subset of beamfocusing parameters for different transmission layers and one or more local FF beams indices.

### UE Reporting of Selected Beamfocusing Parameters

To indicate one or more selected beamfocusing parameters, the UE may report one or any combination of an integer indicating number of selected beamfocusing parameters, one or more global parameter indices of selected of beamfocusing parameters (e.g., a global parameter index indicates index of a selected beamfocusing parameter from a global configured set of beamfocusing parameters), one or more local parameter indices of selected beamfocusing parameters (e.g., a local parameter index indicates index of a selected beamfocusing parameter from a selected subset of beamfocusing parameters, or a local parameter index indicates index of a selected beamfocusing parameter from a constructed subset of beamfocusing parameters), an integer indicating one or more selected global beamfocusing parameters (for instance, the UE may apply a configured algorithm that convert the parameter indices of selected global beamfocusing parameters to an integer value), an integer indicating one or more selected local beamfocusing parameters from a configured subset (for instance, the UE may apply a configured algorithm that convert the parameter indices of selected local beamfocusing parameters from a subset to an integer value), the region associated with the selected beamfocusing parameter (e.g., the region index, the index of the DL RS associated with the region, the range index of the distance range associated with the region, the range index of the angle range associated with the region, and a combination of the range index of angle range and range index of distance range associated with the region), and the distance associated with the selected beamfocusing parameter (e.g., the distance index, the range index of the distance range, index of the upper bound distance of the distance range, and the index of the lower bound distance of the distance range).

In the case of layer-dependent beamfocusing parameters, the UE may report one or more of the described parameters per transmission layer. For instance, the UE may report one or more sets of selected beamfocusing parameters where a first set may include one or more selected beamfocusing parameters for a first transmission layer while a second set may include one or more selected subsets of beamfocusing parameters for a second transmission layer, and so on.

### UE Reporting of Association Between Selected FF Beams and Selected Beamfocusing Parameters

To indicate association between reported FF beams and reported beamfocusing parameters, the UE may report one or any combination of FF beams and their associated beamfocusing parameters in the same order (e.g., for each transmission layer, where the order for reporting these parameters may be ascending order of beam indices of selected FF beams, descending order of beam indices of selected FF beams, ascending order of parameter indices of selected beamfocusing parameters, e.g., for a transmission layer, descending order of parameter indices of selected beamfocusing parameters, e.g., for a transmission layer, ascending order of amplitude of selected FF beams, or e.g., descending order of amplitude of selected FF beams), different tuples of parameters (e.g., FF beam-parameter association tuple) where each FF beam-parameter association tuple may include one or any combination of one or more global FF beams indices, one or more local FF beams indices, one or more local parameter subsets indices of one or more local subsets of beamfocusing parameters, one or more global parameter subsets indices of one or more global subsets of beamfocusing parameters, one or more global parameter indices of one or more global beamfocusing parameters, one or more local parameter indices of one or more local beamfocusing parameters, integer value reflecting one or more global FF beams, integer value reflecting one or more local FF beams, integer value reflecting one or more global beamfocusing parameters, integer value reflecting one or more local beamfocusing parameters, one or more indices of reported FF beams, one or more indices of reported FF beams to which beamfocusing parameters are applied, indication for a transmission layer, one or more sets of selected subset of beamfocusing parameters for different transmission layers, and one or more sets of selected beamfocusing parameters for different transmission layers).

The parameters in each FF beam-parameter association tuple are logically connected (associated with each other). For example, a FF beam-parameter association tuple may include one or more local FF beams indices, one or more global parameter subsets indices, and one or more local parameter indices, one or more global FF beams indices and one or more global parameter indices, one or more global FF beams indices, one or more local parameter subsets indices, and one or more local parameter indices, one or more global FF beams indices and one or more local parameter indices, one or more beam indices of reported FF beams, one or more global parameter subsets indices, and one or more local parameter indices, one or more beam indices of reported FF beams to which beamfocusing parameters are applied, one or more global parameter subsets indices, and one or more local parameter indices, an integer indicating one or more global FF beams and one or more local parameter indices, an integer indicating one or more global FF beams, one or more local parameter subsets indices, and one or more local parameter indices, an integer indicating one or more global FF beams, one or more local parameter subsets indices, and an integer indicating one or more local beamfocusing parameters, one or more local FF beams indices and one or more sets of selected beamfocusing parameters for different transmission layers and one or more local FF beams indices, one or more global parameter subsets indices, one or more local parameter indices, and a transmission layer index.

### UE Reporting of Groups of FF Beams

To indicate one or more group of FF beams and association between different reported FF beams and groups of FF beams, the UE may report one or any combination of the number of groups of FF beams, the number of FF beams in each group of FF beams, one or more integers where each integer indicates the FF beams belonging to the same group (e.g., an integer may reflect the beam indices of selected FF beams from a configured codebook of FF beams, or may reflect the beam indices of the selected FF beams from reported FF beams) where a first and second integers are associated with a first and second groups of FF beams, respectively, a bitmap indicating the group index for each reported FF beam (for instance, in case the UE reports 4 FF beams and the UE decides on 3 groups, the UE sends 8 bits representing the groups of FF beams for each reported FF beams; in particular, the first two bits indicates the group index for the first FF beam and the following two bits reflects the group index for the second reported FF beam and so on), one or more tuples of beam indices (e.g., FF beams tuple) where each FF beams tuple is associated with a group of FF beams (for instance, a first and a second reported FF beams tuples are associated with a first and a second group of FF beams, respectively, the size of each FF beams tuple is equal to the number of FF beams in its corresponding group of FF beams; for instance, a FF beams tuple may include one or more beam indices of the selected FF beams for the corresponding group of FF beams from a configured codebook of FF beams, and a FF beams tuple may include one or more beam indices of the selected FF beams for the corresponding group of FF beams from reported FF beams).

### UE Reporting of Association Between Groups of FF Beams, Subsets of Beamfocusing Parameters, and Beamfocusing Parameters

To indicate association between reported groups of FF beams, reported subsets of beamfocusing parameters, and reported beamfocusing parameters, the UE may report one or any combination of a group of FF beams and their associated subsets of beamfocusing parameters and beamfocusing parameters in the same order (e.g., for a transmission layer, where the order for reporting these parameters may be ascending order of group indices of reported groups of FF beams, descending order of group indices of reported groups of FF beams, ascending order of parameter indices of selected beamfocusing parameters, e.g., for a transmission layer, descending order of parameter indices of selected beamfocusing parameters, e.g., for a transmission layer, ascending order of parameter subset indices of selected subsets of beamfocusing parameters, e.g., for a transmission layer, and descending order of parameter subset indices of selected subsets of beamfocusing parameters, e.g., for a transmission layer), different tuples of parameters (e.g., group-parameter association tuple) where each group-parameter association tuple may include one or any combination of a group index of a reported group of FF beams, one or more local parameter subsets indices of one or more local subset of beamfocusing parameters, one or more global parameter subsets indices of one or more global subset of beamfocusing parameters, one or more global parameter indices of one or more global beamfocusing parameters, one or more local parameter indices of one or more local beamfocusing parameters, an integer value reflecting one or more global beamfocusing parameters, an integer value reflecting one or more local beamfocusing parameters, an indication for a transmission layer, one or more sets of selected subset of beamfocusing parameters for different transmission layers, and one or more sets of selected beamfocusing parameters for different transmission layers.

The parameters in each group-parameter subset association tuple are logically connected (associated with each other). For example, a group-parameter association tuple may include a group index of a reported group of FF beams, one or more global parameter subsets indices, and one or more local parameter indices, a group index of a reported group of FF beams, one or more local parameter subsets indices, and one or more local parameter indices, a group index of a reported group of FF beams and one or more global parameter indices, a group index of a reported group of FF beams and one or more local parameter indices, a group index of a reported group of FF beams, one or more global parameter subsets indices, one or more local parameter indices, a transmission layer index, and a group index of a reported group of FF beams and one or more sets of selected beamfocusing parameters for different transmission layers.

UE Reporting of One or More Parameters Describing Attributes of a UE Constructed Precoder with Type “NF Precoder with Per FF Beam Beamfocusing Parameter”

To indicate attributes of a UE constructed precoder with type “NF precoder with per-FF beam beamfocusing parameter”, using one or more of the previously described solutions, the UE may report one or any combination of an indication for applied phase calculation function for precoder determination, one or more selected FF beams for constructing NF beams, one or more selected subset(s) of beamfocusing parameters (e.g., one or more selected subset(s) of beamfocusing parameters for each transmission layer, or one or more selected subset(s) of beamfocusing parameters independent of transmission layers), one or more selected beamfocusing parameters for constructing NF beams (e.g., one or more selected beamfocusing parameters for each transmission layer, or one or more selected beamfocusing parameters independent of transmission layers), an association between selected FF beams and selected subsets of beamfocusing parameters, an association between selected FF beams and selected beamfocusing parameters, the strongest beam (e.g., strongest NF beam), amplitude coefficients of selected beams (e.g., NF beams), e.g., amplitude coefficients are reported for the strongest beam (amplitude coefficient of strongest beam is set 1), and phase coefficients of selected and beams (e.g., NF beams), e.g., phase coefficients are reported for the strongest beam (phase coefficient of strongest beam is set 0).

UE Reporting of One or More Parameters Describing Attributes of a UE Constructed Precoder with Type “NF Precoder with Per Group of FF Beams Beamfocusing Parameter”

To indicate attributes of a UE constructed precoder, e.g., with type “NF precoder with per Group of FF beams beamfocusing parameter”, using one or more of the previously described solutions, the UE may report one or any combination of an indication for applied phase calculation function for precoder determination, one or more selected FF beams for constructing NF beams, an indication for one or more groups of FF beams, one or more selected subset(s) of beamfocusing parameters (e.g., one or more selected subset(s) of beamfocusing parameters for each transmission layer, or one or more selected subset(s) of beamfocusing parameters independent of transmission layers), one or more selected beamfocusing parameters for constructing NF beams (e.g., one or more selected beamfocusing parameters for each transmission layer, or one or more selected beamfocusing parameters independent of transmission layers), an association between groups of FF beams and subsets of beamfocusing parameters, an association between groups of FF beams and beamfocusing parameters, the strongest beam (e.g., strongest NF beam), amplitude coefficients of selected beams (e.g., NF beams), e.g., amplitude coefficients are reported for the strongest beam (amplitude coefficient of strongest beam is set 1), and phase coefficients of selected and beams (e.g., NF beams), e.g., phase coefficients are reported for the strongest beam (phase coefficient of strongest beam is set 0).

UE Reporting of One or More Parameters Describing Attributes of a UE Constructed Precoder with Type “Hybrid NF-FF Precoder”

To indicate attributes of a UE constructed precoder, e.g., with type “hybrid NF-FF precoder”, using one or more of the previously described solutions, the UE may report one or any combination of one or more selected FF beams, the number of FF beams and/or NF beams, the strongest beam (e.g., strongest NF beam), amplitude coefficients of selected beams (e.g., FF beams and NF beams), e.g., amplitude coefficients are reported for the strongest beam (amplitude coefficient of strongest beam is set 1), phase coefficients of selected and beams (e.g., FF beams and NF beams), e.g., phase coefficients are reported for the strongest beam (phase coefficient of strongest beam is set 0), an indication for one or more selected FF beams for constructing NF beams, and an indication for one or more selected FF beams for which no beamfocusing parameters are applied.

For indicated selected FF beams for constructing NF beams (e.g., for which beamfocusing parameters are applied), the UE can report one or more of an indication for applied phase calculation function for precoder determination, and an indication whether the approach “per FF beam beamfocusing parameter” or the approach “per group of FF beams beamfocusing parameter”, or similar, is applied. For instance, the UE may report an index representing considered approach for applying beamfocusing parameters to selected FF beams. Alternatively, the UE may report a string variable representing considered approach for applying beamfocusing parameters to selected FF beams.

In case the UE indicates per FF beam beamfocusing parameter, the UE reports one or more of one or more selected subset(s) of beamfocusing parameters (e.g., one or more selected subset(s) of beamfocusing parameters for each transmission layer, or one or more selected subset(s) of beamfocusing parameters independent of transmission layers), one or more selected beamfocusing parameters for constructing NF beams (e.g., one or more selected beamfocusing parameters for each transmission layer, or one or more selected beamfocusing parameters independent of transmission layers), an association between selected FF beams for constructing NF beams (e.g., FF beams to which beamfocusing parameters are applied) and beamfocusing parameters, and an association between selected FF beams (e.g., FF beams to which beamfocusing parameters are applied) for constructing NF beams and subsets of beamfocusing parameters.

In case the UE indicates per group of FF beams beamfocusing parameter, UE reports one or more of the number of groups of FF beams, an indication for different groups of FF beams, one or more selected subset(s) of beamfocusing parameters (e.g., one or more selected subset(s) of beamfocusing parameters for each transmission layer, or one or more selected subset(s) of beamfocusing parameters independent of transmission layers), one or more selected beamfocusing parameters for constructing NF beams (e.g., one or more selected beamfocusing parameters for each transmission layer, or one or more selected beamfocusing parameters independent of transmission layers), an association between groups of FF beams (e.g., FF beams to which beamfocusing parameters are applied) and beamfocusing parameters, and an association between groups of FF beams (e.g., FF beams to which beamfocusing parameters are applied) and subsets of beamfocusing parameters.

In an embodiment, to indicate a determined hybrid NF/FF precoder, the UE reports one or more of a first precoder (e.g., FF precoder), a second precoder (e.g., NF precoder), one or more scaling factors, and an association between scaling factor(s) and reported precoders.

In case the UE reports an FF beam used for constructing a NF beam, the indicated FF beam may for instance belong to the configured codebook of FF beams for constructing NF beams, and/or the subset of FF beams for constructing NF beams.

In case the UE reports an FF beam used for constructing an FF beam, the indicated FF beam may for instance belong to the configured codebook of FF beams for constructing FF beams, and/or the subset of FF beams for constructing FF beams.

### UE Determination Whether to Send Updated or New Precoder

The UE can determine whether to send an update to the latest reported precoder or to send a new precoder based on preconfigured conditions and one or more UE measurements.

### UE is Configured Whether to Report Updated or New Precoder

The NW may provide information to the UE indicating whether the UE is to report updated or new precoder attributes.

The UE may determine to report the updated precoder or a new precoder to the gNB based on the configured CSI reporting. For example, the UE may be configured with different CSI reporting configuration with different periodicities.

The UE may be configured with CSI reporting, e.g., periodic CSI reporting configuration, semi-persistent CSI reporting configuration, aperiodic CSI reporting configuration, that can be used for reporting the precoder. The UE may further receive an indication from the gNB to determine, and in some cases, whether to report, one or more reporting choice(s) from a choice pool. The choice pool may consist of any combination (one or more) of “not report any updated precoder or new precoder,” “report updated precoder,” “report new precoder,” and “report both updated precoder and new precoder”. The indication may be signaled to the UE through any one of or a combination of RRC signaling, MAC-CE and DCI.

The UE may be configured with CSI reporting, e.g., periodic CSI reporting configuration, semi-persistent CSI reporting configuration, aperiodic CSI reporting configuration, with the precoder type, e.g., update precoder or new precoder, associated with the CSI reporting as already described. For one instance, the UE may be configured with a CSI reporting (e.g., CSI reporting setting) associated with reporting an updated precoder, or the UE may be configured with a CSI reporting (e.g., CSI reporting setting) associated with reporting a new precoder.

### UE Measurements to Decide on Reporting Updated or New Precoder

The UE can perform different measurements to use to determine whether to report an updated or new precoder attributes.

In one example, the UE may compare a previous reported precoder (latest reported precoder, e.g., latest reported new precoder or latest reported updated precoder) and a new precoder (current determined precoder). For instance, the UE compares the types of previous and current determined precoders, or compares the determined attributes of previous and current determined precoders.

In another example, the UE may measure the time elapsed since UE reported latest new precoder.

### UE Determines Whether to Send Updated or New Precoder

The UE may determine reporting updated or new precoder attributes based on at least one of UE measurements and preconfigured conditions, and an indication from the NW.

The UE determines whether to send updated or new precoder based on the indication or configuration from the NW.

In one example, the UE determines whether to send updated or new precoder based on CSI reporting periodicity. The UE may report the updated precoder on the CSI reporting with shorter periodicity and report the new precoder on the CSI reporting with longer periodicity.

In another example, the UE determines to report updated or new precoder based on the received indication, e.g., as configured in an indicated aperiodic CSI trigger state, indicating one or more of reporting choice, e.g., not report any updated precoder or new precoder, report updated precoder, report new precoder, and report both updated precoder and new precoder. The UE may report the updated precoder or new precoder as indicated by the received indication.

In another example, the UE determines to report the updated or new precoder based on the reporting choice associated with the configured CSI reporting configuration.

### UE Determines Whether to Send Updated or New Precoder Based on the Measurement

In one example, the UE determines whether to send updated or new precoder based on the comparison between a current precoder and a previously reported precoder, e.g., corresponding to the same CSI reporting configuration, wherein a current precoder may have been determined by the UE, e.g., based on the latest received associated RS for CSI/channel measurement, but not yet reported. An updated or new precoder may be based on the current precoder.

For example, the UE may report an updated precoder if previous and current precoder has the same type, report a new precoder if previous and current precoder has different types, report an updated precoder if the number of different FF beams between a current and previous precoder is below a threshold, report a new precoder if the number of different FF beams between a current and previous precoder is above a threshold, report an updated precoder if a current and a previous precoder shares the same FF beams but have one or more different beamfocusing parameters, report an updated precoder if a current and a previous precoder shares the same beamfocusing parameters but have one or more different FF beams, report an updated precoder if the number of beams with different FF beams and/or beamfocusing parameters between a current and a previous precoder is below a threshold, and report a new precoder if the number of beams with different FF beams and/or beamfocusing parameters between a current and a previous precoder is above a threshold.

In another example, the UE determines whether to send updated or new precoder based on the measured elapsed time. For example, the UE may report a new precoder if time elapsed since reporting latest new precoder is above a threshold. The UE may report an updated precoder if time elapsed since reporting latest new precoder is below a threshold.

### UE Determination of Reporting Content of Updated Precoder

The UE can determine the content to be reported for indicating an update to latest reported precoder for different types of precoder based on configurations, e.g., determining the format to use to report updated precoder, and the content based on determined reporting format.

### UE Determines/Selects Format for Reporting an Updated Precoder

The UE can determine the format for reporting an updated precoder based on received indication from the NW.

In an embodiment, the UE may receive an indication for a reporting format of an updated precoder, for example a bitmap reflecting a certain reporting format of an updated precoder, or a string variable indicating a certain reporting format of an updated precoder.

UE can determine the format for reporting an updated precoder based on CSI report configurations.

In an embodiment, the UE may be configured with an association between different CSI report configurations and different formats for reporting an updated precoder. The UE may determine (i.e., select) a reporting format of an updated precoder based on the associated reporting format with the CSI report configuration (e.g., activated or triggered CSI report configuration).

The UE can determine the format for reporting an updated precoder based on comparison between a previous and a current precoder.

In an embodiment, the UE may determine (i.e., select) a reporting format of an updated precoder based on UE comparison between a new determined (current) precoder and a previous precoder. For example, the UE may determine/select a reporting format “reporting one or more updated FF beams” if a current precoder differs from a previous precoder in one or more FF beams, i.e., attributes of a current and a previous precoders differ in one or more FF beams, may determine/select a reporting format “reporting one or more updated beamfocusing parameters” if a current precoder differs from a previous precoder in one or more beamfocusing parameters, i.e., attributes of a current and a previous precoders differ in one or more beamfocusing parameters, may determine/select a reporting format “reporting one or more updated NF beams” if a current precoder differs from a previous precoder in one or more NF beams (one or more FF beams and their associated beamfocusing parameters), i.e., attributes of a current and a previous precoders differ in one or more FF beams and their associated beamfocusing parameters, may determine/select a reporting format “reporting one or more updated group of FF beams” if a current precoder differs from a previous precoder in one or more group of FF beams, i.e., attributes of a current and a previous precoders differ in one or more groups of FF beams, e.g., one or more of the FF beams belonging to a group of FF beams are different, may determine/select a reporting format “reporting one or more additional FF beams” if a current precoder includes one or more additional FF beams over the FF beams constructing a previous precoder, may determine/select a reporting format “reporting one or more additional beamfocusing parameters” if a current precoder includes one or more additional beamfocusing parameters over the beamfocusing parameters constructing a previous precoder, UE may determine/select a reporting format “reporting one or more additional NF beams” if a current precoder includes one or more additional NF beams over the NF beams constructing a previous precoder, and may determine/select a reporting format “reporting one or more additional group of FF beams” if a current precoder includes one or more additional group of FF beams over the groups of FF beams constructing a previous precoder.

In another embodiment, the UE may determine the best NF beam (e.g. NF precoder based on enhanced type I codebook framework for NF, a NF precoder with the best NF beam) based on received DL CSI-RS where the UE determines best NF beam through selecting an FF beam and a beamfocusing parameter. Then, the UE may determine the difference between the determined best NF beam and the best NF beam in a previous precoder, for example the difference (e.g., difference in beam index) between the corresponding selected FF beams, or the difference (e.g., difference in parameter index and/or difference in parameter subset index) between the corresponding selected beamfocusing parameters.

Then, the UE determines the format for reporting updated precoder based on the measured difference between the determined best NF beam and the best NF beam in a previous precoder. The UE may select a reporting format, for example, “reporting one or more updated FF beams” if the difference in beam index is above a threshold, “reporting one or more updated beamfocusing parameters” if the difference in parameter index is above a first threshold and/or the difference in parameter subset index is above a second threshold, and “reporting one or more updated NF beams” if the difference in beam index is above a threshold and the difference in parameter index is above a first threshold and/or the difference in parameter subset index is above a second threshold.

### UE Determines Attributes of an Updated Precoder

In an embodiment, the UE determines one or more attributes of an updated precoder using one or any combination of determination based on comparison between a previous and a new precoder, and determination based on determined reporting format of the updated precoder and one or more measurements.

### Determination Based on Comparison Between a Previous and a New Precoder

In an embodiment, the UE determines attributes of an updated precoder based on comparison between a new determined (current) precoder and a previous precoder. For instance, the UE compares a current precoder and a previous precoder to determine one or more parameters indicating an updated precoder, for instance, parameters indicating one or more attributes of a current precoder with different values compared to their corresponding values in a previous precoder, or parameters indicating one or mor attributes of a current precoder that were not included in a previous reported precoder, e.g., additional parameter in a current precoder that were not included in a previous precoder.

### Determination Based on Determined Reporting Format of the Updated Precoder and One or More Measurements

In an embodiment, the UE may determine one or more attributes of the updated precoder based on the determined reporting format of the updated precoder and one or more measurements. For instance, determination based on UE determination of its moving direction, determination based on one or more conditions/methods for determining one or more contents of certain precoder types, determination based on cross correlation determination, and determination based on absolute difference between beamfocusing parameters of different beams, each of which will now be described in detail.

### Determination Based on UE Determination of its Moving Direction

The UE may determine one or more attributes of the updated precoder based on UE measurements of moving direction after reporting a previous precoder where UE may determine its moving direction, e.g., moving towards a TRP, moving away from a TRP based on a positioning and/or sensing mechanism, determination of UE distance from a TRP, measurement(s) on RS(s), e.g., RSRP, SINR, etc.

For example, the UE may compare its previous RSRP with a current RSRP and if the UE observes an increase in RSRP, the UE determines its moving direction to be towards a TRP. If the UE observes a decrease in RSRP, the UE determines its moving direction to be away from a TRP. Similarly, the UE may compare its distance to a TRP with a previous measured distance with the TRP, and if UE observes a decrease in distance, it determines its moving direction to be towards a TRP. Conversely, in case the UE observes an increase in distance, it determines its moving direction to be away from a TRP.

The UE may determine one or more attributes of the updated precoder based on UE measurements of moving direction.

For instance, the UE may determine one or more updated or additional beamfocusing parameters based on UE moving direction, e.g., towards or away from a TRP. The UE may determine one or more of updated or additional beamfocusing parameters to be larger than one or more of reported beamfocusing parameters of a previous precoder if, for example, UE moves toward a TRP. The UE may determine one or more of updated or additional beamfocusing parameters to be smaller than one or more of reported beamfocusing parameters of a previous precoder if, for example, UE moves away from a TRP. In case the UE determines an updated precoder with format “reporting an updated beamfocusing parameter associated with strongest FF beam”, the UE may determine an updated beamfocusing parameter value to be larger than a previous beamfocusing parameter associated with strongest FF beam, if, for example, the UE moves toward a TRP. In case the UE determines an updated precoder with format “reporting an updated beamfocusing parameter associated with strongest FF beam”, the UE may determine an updated beamfocusing parameter value to be smaller than a previous beamfocusing parameter associated with strongest FF beam, if, for example, the UE moves away from a TRP. In case the UE determines an updated precoder with format “reporting one or more updated beamfocusing parameters”, the UE may determine one or more updated beamfocusing parameters where each updated beamfocusing parameter is larger than its corresponding previous beamfocusing parameter if, for example, the UE moves toward a TRP. The correspondence between an updated beamfocusing parameter and a previous beamfocusing parameter reflects that they both are associated with same FF beam, group of FF beams. In case the UE determines an updated precoder with format “reporting one or more updated beamfocusing parameters”, the UE may determine one or more updated beamfocusing parameters where each updated beamfocusing parameter is smaller than its corresponding previous beamfocusing parameter if, for example, the UE moves away from a TRP. The correspondence between an updated beamfocusing parameter and a previous beamfocusing parameter reflects that they both are associated with same FF beam, group of FF beams.

The UE may determine one or more updated or additional FF beams based on UE moving direction, clockwise or anti-clockwise movement where the UE can determine whether it performs clockwise or anti-clockwise movement through comparing a previous determined angle with a TRP and a current determined angle with a TRP, e.g., calculating the difference between a previous calculated angle (Angle₁) and a current calculated angle with a TRP (Angle₂). If (Angle₂−Angle₁)>0, UE determines anticlockwise movement while if (Angle₂−Angle₁)<0, UE determines clockwise movement.

For example, the UE may determine one or more of updated or additional FF beams to be in the same direction of the UE moving direction where the direction of updated or additional FF beams is determined with respect to one or more previously selected FF beams. For instance, in case the UE makes clockwise/anticlockwise angular movement, the UE selects one or more updated or additional FF beams such that they are located in the clockwise/anticlockwise direction with respect to one or more of previously selected FF beam. In case the UE determines an updated precoder with format “reporting an updated strongest FF beam”, UE may determine an updated FF beam such that it is located in the clockwise/anticlockwise direction with respect to previous selected strongest FF beam, if, for example, the UE makes clockwise/anticlockwise angular movement. In case the UE determines an updated precoder with format “reporting one or more updated FF beams”, the UE may determine one or more updated FF beams where each updated beamfocusing parameter is located in the clockwise/anticlockwise direction w.r.t its corresponding previous FF beam if, for example, the UE makes clockwise/anticlockwise angular movement. The correspondence between an updated FF beam and a previous FF beam reflects that they both are associated with same beamfocusing parameter.

### Determination Based on One or More Conditions/Methods for Determining One or More Contents of Certain Precoder Types

Using similar metrics, methods, optimization criteria used for determining attributes of a new precoder, the UE can construct or determine an updated precoder including one or more of attributes of a previous precoder, updated attributes of a previous precoder, additional attributes to a previous precoder. In particular, the UE can determine one or more attributes of a previous precoder to be changed/updated, updated/new attributes, additional attributes using similar metrics, methods, optimization criteria used for determining attributes of a new precoder.

The UE may also determine attributes to be changed/updated in a previous precoder based on the reporting format of an updated precoder, for instance, in case an updated precoder with format “reporting an updated strongest FF beam”, the UE determines to change the previous strongest FF beam, and in case the UE determines an updated precoder with format “reporting an updated beamfocusing parameter associated with strongest FF beam”, the UE determines to change the previous beamfocusing parameter associated with the strongest FF beam.

### Determination Based on Cross Correlation Determination

In an embodiment, the UE determines attributes of an updated precoder based on cross correlation calculations between an updated or additional beam (e.g., FF or NF beam) and one or more of previously reported beams (e.g., FF and/or NF beams). For example, in case an updated precoder with format “reporting an updated strongest FF beam”, the UE may select the updated strongest FF beam such that the cross-correlation between this FF beam or the NF beam constructed using this beam and previous reported beams (e.g., FF and/or NF beams constructing previous precoder) other than the beam (FF or NF beam) constructed using previous strongest FF beam are below a threshold. For example, in case the UE determines an updated precoder with format “reporting an updated beamfocusing parameter associated with strongest FF beam”, the UE may select the updated beamfocusing parameter associated with the strongest FF beam such that the cross-correlation between the NF beam constructed using this beamfocusing parameter and previous reported beams (e.g., FF and/or NF beams constructing previous precoder) other than the previous strongest NF beam (the beam constructed using previous strongest FF beam and its associated previous beamfocusing parameter) are below a threshold. For example, in case the UE determines an updated precoder with format “reporting one or more additional NF beams”, the UE may select one or more additional NF beams such that the cross-correlation between the additional NF beams and previously reported beams (previous FF beams and/or NF beams constructing previous precoder) are below a threshold. For example, in case an updated precoder with format “reporting one or more updated FF beams”, the UE may select an updated FF beam such that the cross correlation between the updated FF beam or the constructed NF beam from the updated FF beam and one or more of previously reported beams (previous FF beams and/or NF beams constructing previous precoder) are below a threshold.

### Determination Based on Absolute Difference Between Beamfocusing Parameters of Different Beams

In an embodiment, the UE determines updated or additional beamfocusing parameters of an updated precoder based on the absolute difference between the updated or additional beamfocusing parameters and one or more of previous beamfocusing parameters. For example, in case UE determines an updated precoder with format “reporting an updated beamfocusing parameter associated with strongest FF beam”, the UE may select the updated beamfocusing parameter associated with the strongest FF beam such that the absolute differences between the updated beamfocusing parameter associated with the strongest FF beam and previously reported beamfocusing parameters other than the previous beamfocusing parameter associated with the strongest FF beam are below a threshold. For example, in case the UE determines an updated precoder with format “reporting one or more additional beamfocusing parameters”, the UE may select one or more additional beamfocusing parameters such that the absolute differences between the updated beamfocusing parameter and previously reported beamfocusing parameters are below a threshold.

### UE Reporting of Determined Updated Precoder

The UE may report one or more parameters indicating the delta between an updated precoder and a previous precoder to indicate the determined updated precoder. UE may report the number of additional beamfocusing parameters, the number of additional FF beams, the number of additional groups of FF beams, the number of additional NF beams, the number of FF beams to be changed/updated, the number of beamfocusing parameters to be changed/updated, and the number of group of FF beams to be changed/updated.

### UE May Report a Tuple of Parameters (e.g., Updated Precoder Tuple) Indicating an Updated Precoder

Additionally, the UE may report one or more updated precoder tuples including one or more parameters indicating an updated precoder. Each updated precoder tuple may include one or any combinations of the applied format for determining an updated precoder, FF beams to be changed in previous precoder, beamfocusing parameters to be changed, the group of FF beams to be changed, updated FF beams, updated beamfocusing parameters, additional FF beams, additional beamfocusing parameters, additional groups of FF beams, and FF beams in a previous precoder.

The parameters in each updated precoder tuple are logically connected (associated with each other). Each updated precoder tuple may indicate a change in one or more attributes of a previous precoder or one or more additional attributes to a previous precoder for construction of updated precoder. For example, an updated precoder tuple may include applied format for reporting an updated precoder, a FF beam to be changed in previous precoder, an updated FF beam, applied format for reporting an updated precoder, a beamfocusing parameter to be changed in previous precoder, an updated beamfocusing parameter, applied format for reporting an updated precoder, group of FF beams to be changed in a previous precoder, one or more FF beams to be changed in group of FF beams; one or more updated FF beams, applied format for reporting an updated precoder, one or more additional FF beams, applied format for reporting an updated precoder, additional FF beam, additional beamfocusing parameter, applied format for reporting an updated precoder, additional group of FF beams, additional beamfocusing parameter, applied format for reporting an updated precoder, additional beamfocusing parameter, FF beam in a previous precoder, applied format for reporting an updated precoder, one or more FF beams to be changed in previous precoder, one or more updated FF beams (association between each FF beam to be changed in a previous precoder and updated FF beams need to be indicated, e.g., FF beams to be changed and updated FF beams are reported in the same order), applied format for reporting an updated precoder, one or more beamfocusing parameters to be changed in previous precoder, one or more updated beamfocusing parameters (association between each beamfocusing parameter to be changed in a previous precoder and updated beamfocusing parameters need to be indicated, e.g., beamfocusing parameters to be changed and updated beamfocusing parameters are reported in the same order), and applied format for reporting an updated precoder, one or more additional FF beams, one or more additional beamfocusing parameters (association between each FF beam and its associated beamfocusing parameter need to be indicated, e.g., additional FF beams and beamfocusing parameters need to be reported in the same order).

### UE Reporting of Determined Format for Reporting an Updated Precoder

In an embodiment, the UE may indicate a determined and applied format for determining an updated precoder through reporting one or more of format index indicating applied format for determining/reporting the updated precoder, a bitmap indicating which format is applied for determining/reporting the updated precoder, and a string variable indicating which format is applied for determining/reporting the updated precoder.

### UE Reporting of Parameters to be Changed in a Previous Reported Precoder

### UE Reporting of FF Beams in a Previous Reported Precoder, e.g., FF Beams to be Changed in a Previous Precoder

To indicate one or more FF beams in a previous reported precoder, e.g., FF beams to be changed in a previous precoder, the UE may report one or any combination of, in case the previous precoder includes multiple FF beams, each FF beam is associated with a local beam index based on its order in the previous reported precoder and the UE may report one or more parameters indicating the FF beams in previous precoder based on their local beam indices in the previous precoder (e.g., local beam indices of FF beams in the previous precoder, an integer value indicating one or more FF beams to be changed. For instance, UE may apply a configured algorithm that convert the local beam indices of FF beams, e.g., to be changed, in the previous precoder to an integer value, and a bitmap indicating which FF beams, e.g., to be changed, within the previous precoder), one or more local FF beam indices within a group of FF beams, e.g., in case UE reports an updated precoder with format “one or more updated group of FF beams”, UE reports a tuple including a group index of a group of FF beams, and one or more of the described parameters for reporting one or more selected FF beams for precoder construction (see section 4.5), e.g., UE can report FF beams to be changed in a previous precoder in a similar way to reporting one or more selected FF beams determined for precoder construction.

### UE Reporting of Beamfocusing Parameters to be Changed in a Previous Reported Precoder

To indicate one or more selected beamfocusing parameters to be changed in a previous reported precoder, the UE may report one or any combination of, in case the previous precoder includes multiple beamfocusing parameters, each beamfocusing parameter is associated with a local parameter index based on its order in the previous reported precoder, the UE may report one or more parameters indicating the beamfocusing parameters to be changed based on their local parameter indices in a previous reported precoder (e.g., local parameter indices of beamfocusing parameters in the previous precoder, an integer value indicating one or more beamfocusing parameters to be changed, for instance, UE may apply a configured algorithm that converts the local parameter indices of beamfocusing parameters to be changed in the previous precoder to an integer value, and a bitmap indicating which beamfocusing parameters to be changed within the previous precoder), and one or more of the described parameters for reporting one or more selected beamfocusing parameters for precoder construction, e.g., UE can report beamfocusing parameters to be changed in a previous precoder in a similar way to reporting one or more selected beamfocusing parameters determined for precoder construction.

### UE Reporting of Other Parameters for Indicating Attributes of an Updated Precoder

To indicate an updated precoder similar to reporting one or more attributes for indicating a new precoder, the UE may report/indicate one or more of a group of FF beams to be changed in a similar way to reporting a group of FF beams constructing a new precoder, an updated group of FF beams in a similar way to reporting a group of FF beams constructing a new precoder, an additional group of FF beams in a similar way to reporting a group of FF beams constructing a new precoder, one or more updated FF beams in a similar way to reporting one or more FF beams constructing a new precoder, one or more additional FF beams in a similar way to reporting one or more FF beams constructing a new precoder, one or more updated beamfocusing parameters in a similar way to reporting one or more beamfocusing parameters constructing a new precoder, one or more additional beamfocusing parameters in a similar way to reporting one or more beamfocusing parameters constructing a new precoder, the strongest beam (e.g., NF or FF beam) in the updated precoder, amplitude coefficients of selected NF and FF beams (e.g., amplitude coefficients are reported for the strongest beam (amplitude coefficient of strongest beam is set 1)), and phase coefficients of selected NF and FF beams (e.g., phase coefficients are reported for the strongest beam (phase coefficient of strongest beam is set 0)).

UE Construction of a Precoder Using FF and/or NF Beams Codebooks

### UE Configurations and Construction of NF Codebook

UE Configurations of a NF Codebook and/or an FF Codebook

In an embodiment, the UE is configured with an FF codebook and/or a NF codebook. A NF codebook includes one or more NF spot beams that, for example, may focus the energy at different angular directions and/or different focus distances.

A UE may be configured with one or more parameters for constructing a NF codebook. For instance, UE may be configured with one or more of a FF codebook for constructing a NF codebook, a minimum distance and/or a maximum distance defining the NF propagation region, a number of quantization levels for distance quantization, a beamfocusing parameter calculation function to calculate beamfocusing parameters as a function of focus distance, a phase calculation function, e.g., based on first order, second order Taylor series approximation, an association between different phase calculation functions and different distance ranges (e.g., a UE may be configured with a distance threshold where the UE may be associated with a phase calculation function based on second order Taylor series approximation for determining NF beams in the NF codebook with focus distance below a threshold, and the UE may be associated with a phase calculation function based on first order Taylor series approximation for determining NF beams in the NF codebook with focus distance above a threshold, wherein a NF codebook may include NF beams constructed using different phase calculation functions), a minimum and/or a maximum beamfocusing parameters, and a number of quantization levels for beamfocusing parameters.

The UE may be configured with two codebooks of FF beams where the UE may be configured to use a first codebook of FF beams to construct NF codebook (a codebook with NF beams) whereas UE may be configured to use a second codebook of FF beams to construct FF beams.

The UE may be configured with a codebook of FF beams and two subsets of FF beams from the codebook of FF beams where the UE may be configured to use a first subset of FF beams to construct NF codebook (a codebook with NF beams) and to use a second subset of FF beams to construct FF beams.

A configured FF codebook for constructing a NF codebook may include orthogonal and/or non-orthogonal FF beams (e.g., oversampled DFT beams).

### UE Constructs of a NF Codebook

A UE may construct a NF codebook using configured parameters for NF codebook construction. In particular, a UE may construct a NF codebook including one or more NF beams where the number of NF beams in a NF precoder is equal to the multiplication of the number of FF beams (N_{FF}) in a configured FF precoder for constructing NF codebook and the number of configured distance quantization levels (q), e.g., number of focus distances where N_{NF}=N_{FF}*q, e.g., the UE constructs q NF beams from the same FF beam where each NF beam has a different focus distance. Alternatively, the UE may use beamfocusing parameters directly, instead of focus distances, to construct a NF codebook.

The UE can for example construct a NF beam from a FF beam by one or more of determining a beamfocusing parameter based on the focus distance for the NF beam and configured beamfocusing parameter calculation function for calculating beamfocusing parameter as a function of the focus distance, determining a phase correction factor b for constructing a NF beam from a FF beam based on the determined beamfocusing parameter, the angles of the used FF beam for constructing the NF beam, and the configured phase calculation function, and applying the phase correction factor b to the FF beam v_{NF}=v_{FF}⊙b.

Each NF beam within a NF codebook may be associated with a beam index indicating the NF beam index within a NF codebook, two indices where the first index represents the beam index of the FF beam used to construct the NF beam while the second index represents the distance index of the focus distance for which the NF beam is constructed (wherein the beam index of the FF beam may be a global beam index within a codebook of FF beams, and the beam index of the FF beam may be a local beam index within a configured subset of FF beams, where in this case the beam subset index of the subset of FF beams including FF beam used to construct the NF beam should be considered to represent the NF beam), three indices where the first and second indices represent the horizontal and vertical beam indices of the FF beam used to construct the NF beam while the third index represents the distance index of the focus distance for which the NF beam is constructed (wherein the horizontal and vertical beam indices of the FF beam may be global beam indices within a codebook of FF beams, and the horizontal and vertical beam indices of the FF beam may be local beam indices within a configured subset of FF beams where in this case the beam subset index of the subset of FF beams including FF beam used to construct the NF beam should be considered to represent the NF beam).

### NF Codebook Subset Restrictions

A UE may be configured with NF codebook subset restrictions. For instance, the UE may be configured with one or more subsets of NF beams where each subset of NF beams includes one or more NF beams. Also, each subset of NF beams may be configured with maximum allowed amplitude coefficients indicating the maximum amplitude that can be assigned to a selected NF beam from this subset, wherein the maximum amplitude may for example be 0, 1, or a number between 0 and 1. In addition, each subset of NF beams may be configured with a maximum cross-correlation value where this maximum cross-correlation value may indicate the maximum cross-correlation value that selected beams from this subset can have or the maximum cross-correlation value that a selected beam can have with the beams included in this subset of NF beams, e.g., UE needs to calculate the cross-correlation between a selected beam and one or more beams from a subset of NF beams to decide whether to select it for precoder construction or not.

A selected beam may correspond to a beam with a non-zero amplitude coefficient.

### FF Codebook Subset Restrictions

A UE may be configured with FF codebook subset restrictions. For instance, the UE may be configured with one or more subsets of FF beams where each subset of FF beams includes one or more FF beams. Also, each subset of FF beams may be configured with maximum allowed amplitude coefficients indicating the maximum amplitude that can be assigned to a selected FF beam from this subset. In addition, each subset of FF beams may be configured with a maximum cross-correlation value where this maximum cross-correlation value may indicate the maximum cross-correlation value that a selected beam can have with the beams included in this subset of FF beams, e.g., the UE needs to calculate the cross-correlation between a selected beam and one or more beams from a subset of FF beams to decide whether to select it for precoder construction or not.

UE Construction of a New or Updated Precoder Using NF and/or FF Codebook

The UE may construct (i.e. determine) a precoder, e.g., NF precoder, hybrid NF-FF precoder, using at least one of a NF codebook and an FF codebook using metrics, methods, and optimization criteria similar to those used for determining attributes of a new precoder). In particular, the UE determines (i.e., selects) NF beams and/or FF beams constructing a precoder from a NF codebook and/or an FF codebook, respectively, using metrics, methods, conditions, and optimization criteria similar to those used for determining attributes of a new precoder.

The UE may construct (i.e., determine) an updated precoder using a NF codebook and/or an FF codebook using metrics, methods, and optimization criteria similar to those used for determining updated precoder attributes. In particular, the UE can determine/select NF beams and/or FF beams to be changed and updated and/or additional NF beams and/or FF beams constructing a precoder from a NF codebook and/or a FF codebook, respectively, using metrics, methods, conditions, and optimization criteria similar to those used for determining attributes of an updated precoder.

UE Reporting of a New or Updated Precoder Based on NF and/or FF Codebook

To indicate attributes of a UE determined NF precoder, the UE may report one or any combination of beams indices of selected NF beams from NF codebook and an integer value indicating one or more selected NF beams from the codebook of NF beams. For instance, UE may apply a configured algorithm that convert the indices of selected NF beams to an integer value.

The beam index of a NF beam may be indicated through one beam index representing the NF beam index in the codebook of NF beams, one distance index and one beam index where the distance index indicates the focus distance of the NF beam while the beam index represents the beam index of the FF beam used to construct the NF beam (wherein the FF beam index may indicate the beam index of the FF beam in the configured codebook of FF beams for constructing the NF codebook or the beam index of the FF beam in the configured subset of FF beams from the codebook of FF beams for constructing the NF codebook), and one distance index and two beam indices where the first and second beam indices representing the horizontal and vertical beam indices of the FF beam used to construct the NF beam (wherein the two beam indices may indicate the horizontal and vertical beam indices of the FF beam in the configured codebook of FF beams for constructing the NF codebook, or the horizontal and vertical beam indices of the FF beam in the configured subset of FF beams from the codebook of FF beams for constructing the NF codebook).

To indicate attributes of a UE determined hybrid NF-FF precoder, the UE may report one or any combination of a number of FF beams and/or NF beams, beam indices of selected FF beams from a configured codebook of FF beams (e.g., a FF codebook, where the beam index of a FF beam may be indicated through a beam index representing the FF beam index in the codebook of FF beams, a beam index representing the FF beam index in a configured subset of FF beams for constructing FF beams from the codebook of FF beams, two beam indices where the first and second beam indices representing the horizontal and vertical beam indices of the selected FF beam in the codebook of FF beams, and two beam indices where the first and second beam indices representing the horizontal and vertical beam indices of the selected FF beam in the configured subset of FF beams for constructing the FF beams from the codebook of FF beams), an integer value indicating one or more selected FF beams from the configured codebook of FF beams (where, for instance, the UE may apply a configured algorithm that convert the indices of selected FF beams to an integer value), an integer value indicating one or more selected FF beams in the configured subset of FF beams for constructing the FF beams from the configured codebook of FF beams, selected NF beams where selected NF beams can be indicated using one or more of above described methods for reporting NF beams for NF precoder construction, the strongest NF beam, amplitude coefficients of selected NF and/or FF beams (e.g., amplitude coefficients are reported with reference to the strongest NF beam (amplitude coefficient of strongest NF beam is set 1), and phase coefficients of selected NF and FF beams (e.g., phase coefficients are reported with reference to strongest NF beam (phase coefficient of strongest NF beam is set 0).

In an embodiment, to indicate a determined hybrid NF/FF precoder, the UE may report one or more of a first precoder (e.g., FF precoder), a second precoder (e.g., NF precoder), one or more scaling factors, and an association between scaling factor(s) and reported precoders.

The UE may report a NF beam by reporting its beam index within a subset of NF beams where the subset of NF beams may be constructed, e.g., by the UE and/or the network, such that the cross-correlation between the NF beams in the subset of NF beams is below a threshold value. For instance, for a selected NF beam, UE may determine the subset of NF beams to which this NF beam belongs and report the NF beam index within the identified subset of NF beams. In an alternative, the subset of NF beam may include a number of NF beams from a set of NF beams with lowest cross-correlation, wherein the number of NF beams in the subset may be configurable.

The UE may first determine a first NF beam from a (larger) set of NF beams and then determine a subset of NF beams based on the first NF beam and the cross-correlations between the first beam and the beams in the set of NF beams. For instance, the subset of NF beams may include the NF beams in the set of NF beams that have cross-correlation with the first NF beam below a threshold. Alternatively, the subset of NF beams may include a number, e.g., a configurable number, of NF beams from the set of NF beams with lowest cross-correlation with the first NF beam. This way, the UE may need to report the first NF beam using more bits, since it is selected from the (larger) set of NF beams. However, subsequent NF beams, selected from the subset of NF beams corresponding to the first NF beam, may be reported with fewer bits, since the subset of NF beams may be smaller than the set of NF beams. This may save CSI reporting overhead with relatively low impact on performance.

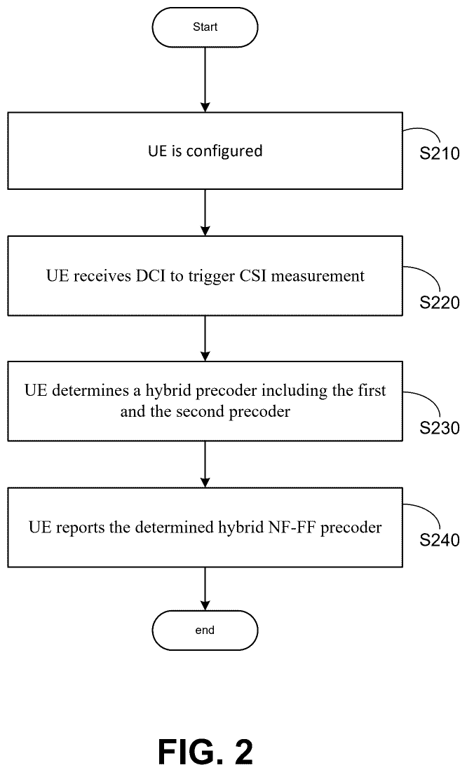

FIG. 2 illustrates a flowchart of a method of construction and reporting of a hybrid precoder with two precoders according to an embodiment of the present principles.

Briefly speaking, in this example embodiment, a UE is configured with a precoder type “hybrid precoder” and one or more parameters for constructing a hybrid precoder. The UE determines a hybrid precoder including a first precoder (e.g., FF precoder) and a second precoder (e.g., NF precoder) using one or more of the configured parameters. Then, the UE reports the beams constructing the first and second precoders in the hybrid precoder.

In step S210, the UE is configured. The UE receives configuration information, for example from the network, and uses the received information for its configuration.

The configuration information includes one or more of a CSI-configuration including resource type (e.g., aperiodic CSI-RS), a precoder type (for example, a first type (e.g., FF), a second type (e.g., NF), a third type (e.g., Hybrid)), a first codebook (e.g., codebook based on FF basis beams), a second codebook (e.g., codebook of phase correction vectors), a total number of beams (L) in the configured precoder type, a maximum number of basis beam per the first and the second precoders, a pair of scaling factor for the first and the second precoders, and a target performance metric (e.g., SINR, minimum inter/intra-precoder interference for precoder construction).

In step S220, the UE receives downlink control information (DCI) to trigger an aperiodic CSI measurement on the configured downlink (DL) CSI-RS.

When the third type precoder (i.e., hybrid) is configured based on the received DL CSI-RS, in step S230, the UE determines a hybrid precoder including the first and the second precoder, according to the configured maximum number of basis beam per precoder. This can be done by performing one or more of applying the scaling factors for each precoder, and determining the combination of the first and the second precoders (i.e., hybrid precoder) by selecting the basis beams that results in meeting the target performance metric, e.g., minimum inter/intra-precoder interference, where the first precoder is selected from the first codebook (e.g., far field codebook) and the second precoder is jointly selected from the first codebook (far field) and the second codebook (phase correction vectors).

In step S240, the UE reports the determined hybrid NF-FF precoder. The UE can use described reporting techniques to report one or more of an indication of the selected beams for constructing the first precoder, an indication of the selected beams for constructing the second precoder, an indication of the determined phase correction vector for each selected beam for constructing the second precoder, and an indication of an association between the selected beams for constructing the second precoder and the selected phase correction vectors.

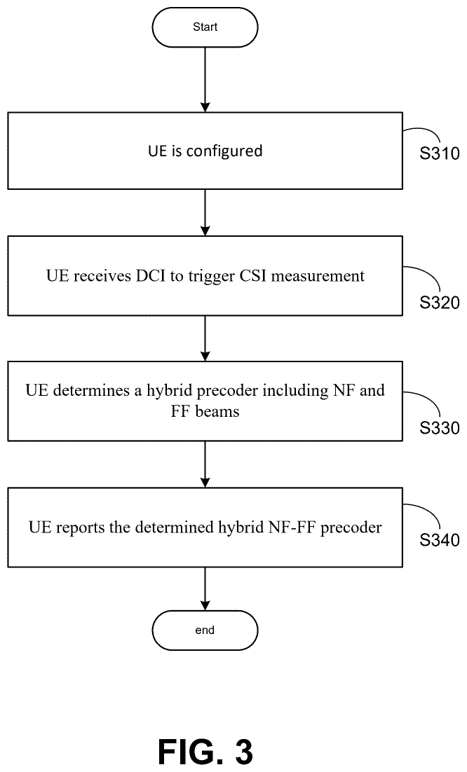

FIG. 3 illustrates a flowchart of a method of construction and reporting of a hybrid NF-FF precoder with FF beams and NF beams according to an embodiment of the present principles.

Briefly speaking, in this example solution, a UE is configured with a precoder type “hybrid NF-FF precoder” and one or more parameters for constructing a hybrid NF-FF precoder. The UE determines the NF beams and/or FF beams constructing a hybrid precoder using one or more of the configured parameters. Then, the UE reports the NF and FF beams constructing the hybrid precoder through reporting the FF beams and beamfocusing parameters associated with one or more of the reported FF beams.

In step S310, the UE is configured. The UE receives CSI configuration information, for example from the network, and uses the received information for its configuration.

The CSI configuration information includes one or more of a CSI-configuration (e.g., aperiodic CSI-RS), precoder type “Hybrid NF-FF precoder”, codebook of FF beams, multiple subsets of beamfocusing parameters, a total number of beams (L) constructing the precoder, a number of NF and/or FF beams in the precoder, and a threshold value indicating maximum cross correlation between beams constructing a precoder.

In step S320, the UE receives downlink control information (DCI) to trigger an aperiodic CSI measurement on the configured downlink (DL) CSI-RS.

In step S330, based on the received DL CSI-RS, the UE determines a hybrid precoder including the number of configured NF beams and the number of configured FF beams, based on the measured CSI-RS.

To determine a NF beam, the UE determines an FF beam from the configured codebook of FF beams and a beamfocusing parameter for the determined FF beam from a configured subsets of beamfocusing parameters.

The UE selects the beams (NF and FF beams) in the precoder such that the cross correlation between any two selected beams is below the configured threshold.

In step S340, the UE reports the determined hybrid NF-FF precoder. The UE can use described reporting techniques to report one or more of selected FF beam(s), an indication for selected FF beams for constructing NF beams (FF beams for which beamfocusing parameters are applied), an indication for selected FF beams for which no beamfocusing parameters are applied, one or more selected beamfocusing parameters, and an association between selected FF beams for constructing NF beams and beamfocusing parameters.

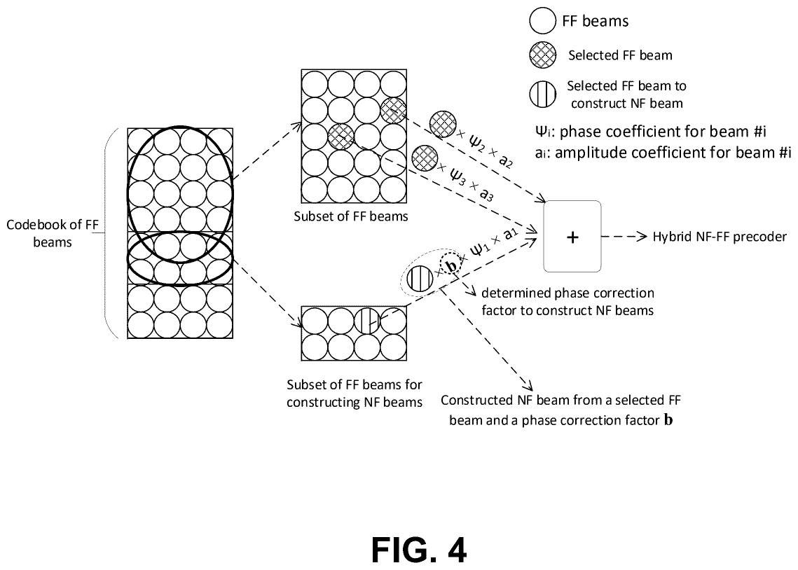

FIG. 4 is a different, schematic illustration of UE determination of a hybrid NF-FF precoder.

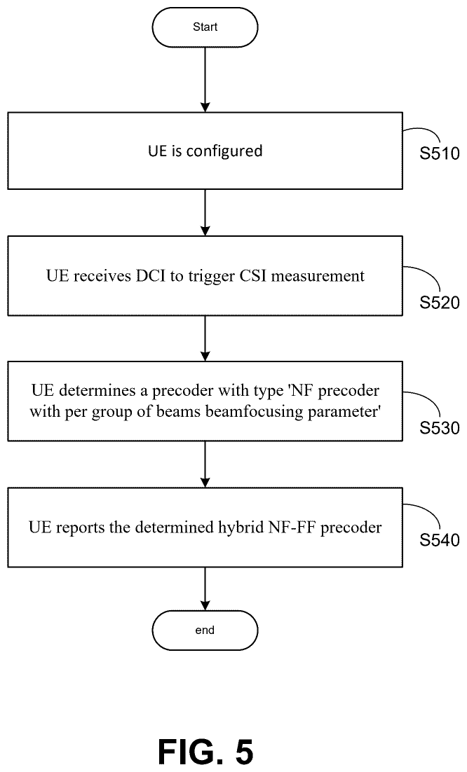

FIG. 5 illustrates a flowchart of a method of construction and reporting of a NF precoder with per group of FF beam beamfocusing parameter according to an embodiment of the present principles.

Briefly speaking, in this example solution, a UE is configured with a precoder type “NF precoder with per group of FF beams beamfocusing parameter” and one or more methods for constructing a NF precoder with per group of FF beams beamfocusing parameter. The UE determines one or more FF beams to be grouped and the beamfocusing parameter for a group of FF beams based on configured methods for constructing a NF precoder with per group of FF beams beamfocusing parameter. Then, the UE reports the determined NF precoder through reporting the different determined groups of FF beams and their associated beamfocusing parameters.

In step S510, the UE is configured. The UE receives CSI configuration information, for example from the network, and uses the received information for its configuration.

The CSI configuration information includes a CSI-configuration (e.g., aperiodic CSI-RS), a precoder type “NF precoder with per group of FF beams beamfocusing parameter”, a codebook of FF beams, one or more subsets of beamfocusing parameters, association information by which each FF beam in the codebook of FF beams is associated with a subset of beamfocusing parameters, information on methods to select beams within a group of FF beams, and information on methods to select beamfocusing parameters for a group of FF beams.

In step S520, the UE receives downlink control information (DCI) to trigger an aperiodic CSI measurement on the configured downlink (DL) CSI-RS.

In step S530, based on the received DL CSI-RS, the UE determines a precoder with type “NF precoder with per group of beams beamfocusing parameter” by determining one or more groups of FF beams and their corresponding beamfocusing parameters based on one or more of configured methods for constructing a precoder with type “NF precoder with per group of beams beamfocusing parameter”.

The UE may determine one or more FF beams from the configured codebook of FF beams and select the FF beams to be grouped in a group of FF beams based on a configured method for selecting FF beams within a group of beams. For example, the UE may select one or more FF beams to be grouped in a group of FF beams such that FF beams correspond to NLoS channel paths are grouped in the same group.

The UE may select a beamfocusing parameter for a group of FF beams based on a configured method for selecting a beamfocusing parameter for a group of FF beams. For example, the UE may select a beamfocusing parameter for a group of FF beams from a subset of beamfocusing parameters associated with the strongest beam in the group of FF beams.

In step S540, the UE reports the determined hybrid NF-FF precoder. The UE can use described reporting techniques to report one or more of selected FF beam(s), a number of constructed group of FF beams, an indication for FF beams within each group of FF beams, one or more selected beamfocusing parameters, one or more selected subsets of beamfocusing parameters, an association between groups of FF beams and beamfocusing parameters, and an association between groups of FF beams and subsets of beamfocusing parameters.

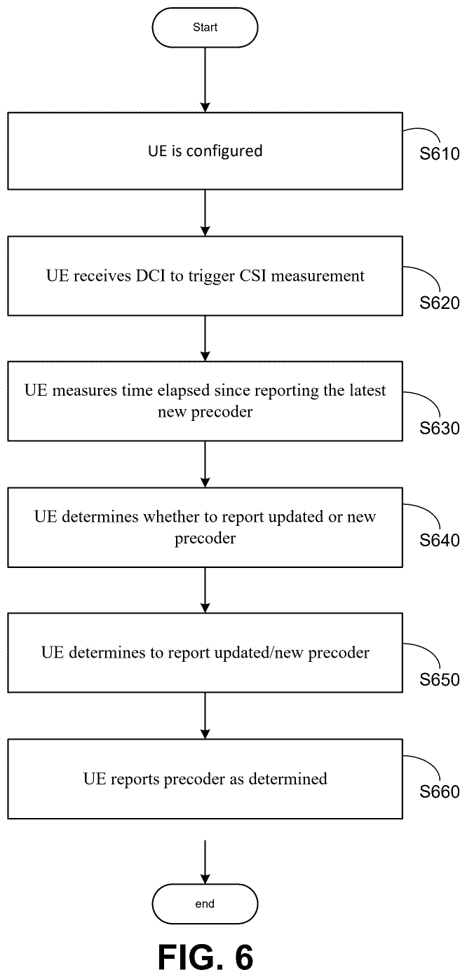

FIG. 6 illustrates a flowchart of a method of determination of reporting updated or new precoder and reporting format of an updated precoder.

Briefly speaking, in this example, a UE is configured with one or more conditions for determining reporting updated or new precoder and one or more conditions for determining a format for reporting updated precoder. The UE measures time elapsed since reporting latest new precoder based on measured elapsed time since reporting latest new precoder. In addition, the UE determines a current strongest NF beam and compares it with the strongest NF beam in a previous reported precoder. Then, the UE determines the format for reporting the updated precoder based on the determined comparison between the current determined strongest NF beam and the strongest NF beam in a previous reported precoder.

In step S610, the UE is configured. The UE receives CSI configuration information, for example from the network, and uses the received information for its configuration.

The CSI configuration information includes a CSI-configuration (e.g., aperiodic CSI-RS), a precoder type, a codebook of FF beams, one or more subsets of beamfocusing parameters, one or more conditions for reporting updated or new precoder, and one or more conditions for determining format for reporting updated precoder.

In step S620, the UE receives downlink control information (DCI) to trigger an aperiodic CSI measurement on the configured downlink (DL) CSI-RS.

In step S630, the UE can measure time elapsed since reporting the latest new precoder.

In step S640, the UE determines whether to report updated or new precoder based on configured conditions and the measured elapsed time since reporting latest new precoder.

For example, the UE can determine to report an updated precoder if measured elapsed time after reporting latest new precoder is below a configured threshold value. Conversely, the UE can determine to report a new precoder if measured elapsed time after reporting latest new precoder is above a configured threshold value.

In step S650, depending on the determination, the UE reports an updated or a new precoder.

In case the UE determines to report updated precoder, it can determine the best NF beam (e.g. NF precoder based on enhanced type I codebook framework for NF, a NF precoder with the best NF beam) based on received DL CSI-RS, where the best NF beam is determined by selecting a FF beam and a beamfocusing parameter.

The UE can then determine the difference between the determined best NF beam and the best NF beam in a previous precoder. For example, the UE can determine the difference (e.g., difference in beam index) between the corresponding selected FF beams. Alternatively, the UE can determine the difference (e.g., difference in parameter index and/or difference in parameter subset index) between the corresponding selected beamfocusing parameters.

The UE can then determine the format for reporting the updated precoder based on the measured difference between the determined best NF beam and the best NF beam in a previous precoder.

The UE can select a reporting format “reporting one or more updated FF beams” if the difference in beam index is above a threshold. The UE can select a reporting format “reporting one or more updated beamfocusing parameters” if the difference in parameter index is above a first threshold and/or the difference in parameter subset index is above a second threshold. The UE can select a reporting format “reporting one or more updated NF beams” if the difference in beam index is above a threshold and the difference in parameter index is above a first threshold and/or the difference in parameter subset index is above a second threshold.

The UE can then determine attributes of the updated precoder based on received DL CSI-RS and the determined format.

In case the US determines to report a new precoder, the UE determines attributes of the new precoder based on received DL CSI-RS.

In step S660, the UE reports one or more of an indication of updated or new precoder, an indication of format of reported updated precoder, and attributes of determined precoder.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A wireless transmit/receive unit, WTRU, comprising at least one processor configured to:
measure one or more downlink, DL, reference signals, RSs, to obtain a measurement result;
determine, based on the measurement result, at least a first set of vectors;
determine, based on the measurement result, at least a second set of vectors having complex valued elements, across which phase progression is non-linear;
determine precoder information comprising at least the first set of vectors and the second set of vectors; and
transmit, to a transmission reception point, information indicating the precoder information.

2. The WTRU of claim 1, wherein:
the at least one processor is configured to determine no more than a first maximum number of vectors for the first set of vectors, and no more than a second maximum number of vectors for the second set of vectors.

3. The WTRU of claim 1, wherein the at least one processor is further configured to:
determine, based on the measurement result, one or more phase correction vectors; and
determine the second set of vectors by respectively applying the one or more phase correction vectors to a determined third set of vectors that respectively are Kronecker products of two vectors having complex valued elements, across which phase progression is linear; and
wherein the information indicating the precoder information further comprises information indicative of the one or more phase correction vectors.

4. The WTRU of claim 3, wherein the at least one processor is further configured to:
determine the first set of vectors from a first subset of a fourth set of vectors that respectively are Kronecker products of two vectors having complex valued elements, across which phase progression is linear; and
determine the third set of vectors from a second subset of the fourth set of vectors.

5. The WTRU of claim 3, wherein the at least one processor is further configured to:
apply identical phase correction vectors to the vectors of the third set.

6. The WTRU of claim 1, wherein:
the first set of vectors correspond to far-field, FF, precoding and the second set of vectors correspond to near-field, NF, precoding.

7. The WTRU of claim 1, wherein:
the precoder information comprises at least one of information indicative of the first set of vectors, information indicative of the second set of vectors.

8. The WTRU of claim 3, wherein the at least one processor is further configured to:
apply the one or more phase correction vectors to the third set of determined vectors using respective element-wise multiplication between the vector and the phase correction vector.

9. The WTRU of claim 1, wherein the at least one processor is further configured to:
determine, based on the measurement result, a first scaling factor for the first set of vectors and a second scaling factor for the second set of vectors; and
apply, before determining the precoder information, the first scaling factor to the first set of vectors and the second scaling factor to the second set of vectors.

10. The WTRU of claim 1, wherein:
the first set of vectors respectively are Kronecker products of two vectors having complex valued elements, across which phase progression is linear.

11. The WTRU of claim 4, wherein:
at least one factor of the Kronecker products has a single element.

12. The WTRU of claim 1, wherein:
the information indicating the precoder information comprises a subset of the vectors of the first set of vectors and the second set of vectors.

13. A method, implemented by a wireless transmit/receive unit, WTRU, comprising:
measuring one or more downlink, DL, reference signals, RSs, to obtain a measurement result;
determining, based on the measurement result, at least a first set of vectors;
determining, based on the measurement result, at least a second set of vectors having complex valued elements, across which phase progression is non-linear;
determining precoder information comprising at least the first set of vectors and the second set of vectors; and
transmitting, to a transmission reception point, information indicating the precoder information.

14. The method of claim 13, wherein:
the first set of vectors comprises no more than a first maximum number of vectors, and the second set of vectors comprises no more than a second maximum number of vectors.

15. The method of claim 13, further comprising:
determining, based on the measurement result, one or more phase correction vectors; and
wherein the second set of vectors are determined by respectively applying the one or more phase correction vectors to a determined third set of vectors that respectively are Kronecker products of two vectors having complex valued elements, across which phase progression is linear; and
wherein the information indicating the precoder information further comprises information indicative of the one or more phase correction vectors.

16. The method of claim 13, wherein:
the first set of vectors correspond to far-field, FF, precoding and the second set of vectors correspond to near-field, NF, precoding.

17. The method of claim 13, wherein:
the precoder information comprises at least one of information indicative of the first set of vectors, information indicative of the second set of vectors.

18. The method of claim 13, further comprising:
determining, based on the measurement result, a first scaling factor for the first set of vectors and a second scaling factor for the second set of vectors; and
applying, before determining the precoder information, the first scaling factor to the first set of vectors and the second scaling factor to the second set of vectors.

19. The method of claim 13, wherein:
the first set of vectors respectively are Kronecker products of two vectors having complex valued elements, across which phase progression is linear.

20. The method of claim 13, wherein:
the information indicating the precoder information comprises a subset of the vectors of the first set of vectors and the second set of vectors.
